(19) United States
(12) Patent Application Publication
(10) Pub. No.: US 2020/0001920 A1
(43) Pub. Date: Jan. 2, 2020

(54) SYSTEMS AND METHODS FOR PREVENTING A JACKKNIFE CONDITION IN A TRACTOR-TRAILER SYSTEM

(71) Applicant: Ohio State Innovation Foundation, Columbus, OH (US)

(72) Inventors: Mohammad Hejase, Columbus, OH (US); Junbo Jing, Columbus, OH (US); John Maroli, Columbus, OH (US); Yasser Bin Salamah, Dublin, OH (US); Lisa Fiorentini, Powell, OH (US); Umit Ozguner, Dublin, OH (US)

(21) Appl. No.: 16/460,646

(22) Filed: Jul. 2, 2019

Related U.S. Application Data
(60) Provisional application No. 62/693,070, filed on Jul. 2, 2018.

(51) Int. Cl. B62D 15/02; B60W 30/18

(52) U.S. Cl. CPC B62D 15/025; B60W 30/18036; B60W 2300/145; B60W 2520/22; B60W 2520/10

(57) ABSTRACT

Systems and methods for preventing a jackknife condition in a tractor-trailer system are described herein. The systems and methods described herein can determine the maneuverable range beyond which jackknifing is inescapable given the tractor vehicle's steering capabilities. The systems and methods described herein can include a plug-in safety governor that provides assurance against system loss of maneuverability.

### CROSS-REFERENCE TO RELATED APPLICATIONS

This application claims the benefit of U.S. provisional patent application No. 62/693,070, filed on Jul. 2, 2018, and entitled “Jackknife Accident Prevention System for Vehicle-Trailer Path Tracking Control,” the disclosure of which is expressly incorporated herein by reference in its entirety.

### BACKGROUND

Jackknifing during tractor-trailer reverse driving presents a major challenge in control system design. At a certain relative body angle, it no longer becomes possible to maneuver the tractor-trailer system. Previous studies have investigated conditions for occurrence of jackknife accidents and developed controllers designed to avoid jackknifing during backward motion. Existing control designs, however, lack compliance with both of steering and steering rate constraints. Additionally, a majority of these solutions are for vehicles with an on-axle hitch (e.g., suitable for robotic vehicles, but not cars/trucks).

### SUMMARY

Systems and methods for preventing a jackknife condition in a tractor-trailer system are described herein. The systems and methods described herein can determine the maneuverable range beyond which jackknifing is inescapable given the tractor's vehicles steering and steering rate capabilities. In some implementations, the systems and methods account for steering constraints such as maximum steering angle range and/or maximum steering angular rates of the tractor vehicle. The systems and methods described herein can include a plug-in safety governor that provides assurance against system loss of maneuverability.

The tractor-trailer system can include a tractor vehicle and a trailer vehicle, where the tractor and trailer vehicles are connected via an off-axle hitch. The systems and method described herein can include a driver assistance system, e.g., a driver assistance system for the tractor-trailer system. The driver assistance system can include a tractor-trailer control module that is configured to steer one or more wheels of the tractor vehicle and a control safety governor module that is configured to supervise the tractor-trailer control module to prevent occurrence of the jackknife condition. For example, the control safety governor module can be configured to adjust a steering command generated by the tractor-trailer control module in response to detecting the jackknife condition. The tractor-trailer control module and the control safety governor module can be implemented by hardware and/or software and include, for example, computer-executable instructions stored in a memory and executed by a computing device. In some implementations, the control safety governor module is a plug-in module.

An example non-transitory computer-readable storage medium having computer-executable instructions stored thereon for preventing a jackknife condition in a tractor-trailer system is described herein. The non-transitory computer-readable storage medium can include computer-executable instructions for receiving a plurality of static parameters for the tractor-trailer system and calculating a maneuverable range for an articulation angle of the tractor-trailer system based on the static parameters. The static parameters can include a geometry of the tractor-trailer system and a steering limit of the tractor vehicle. Additionally, the non-transitory computer-readable storage medium can include computer-executable instructions for receiving a plurality of dynamic parameters for the tractor-trailer system. The dynamic parameters can include a steering command from a tractor-trailer controller, a longitudinal speed of the tractor vehicle, and a measured articulation angle of the tractor-trailer system. Further, the non-transitory computer-readable storage medium can include computer-executable instructions for detecting the jackknife condition when the articulation angle is expected to depart from the maneuverable range.

In some implementations, the non-transitory computer-readable storage medium can further include computer-executable instructions for calculating an expected articulation angle of the tractor-trailer system based on the dynamic parameters, and determining whether the expected articulation angle is within the maneuverable range. The jackknife condition can be detected when the expected articulation angle is outside of the maneuverable range. In these implementations, the expected articulation angle of the tractor-trailer system can be calculated using a kinematic model for the tractor-trailer system. Optionally, an analytical equation can be derived from an approximation of the kinematic model for the tractor-trailer system.

In other implementations, the step of detecting the jackknife condition when the articulation angle is expected to depart from the maneuverable range includes approximating a kinematic model for the tractor-trailer system. The kinematic model for the tractor-trailer system can be approximated under a maximum steering rate condition for the tractor vehicle. Optionally, the step of detecting the jackknife condition when the articulation angle is expected to depart from the maneuverable range can further include deriving an analytical equation from the approximation of the kinematic model for the tractor-trailer system under the maximum steering rate condition for the tractor vehicle.

Alternatively or additionally, the non-transitory computer-readable storage medium can include computer-executable instructions for adjusting the steering command in response to detecting the jackknife condition, and transmitting the adjusted steering command to the tractor vehicle. The step of adjusting the steering command can include adjusting at least one of a commanded steering angle for the tractor vehicle or a commanded steering angular rate for the tractor vehicle. Optionally, in some implementations, the commanded steering angle is reduced. Optionally, in some implementations, the commanded steering angular rate is altered. Optionally, in some implementations, a direction of the commanded steering angle is changed (e.g., the tractor vehicle is commanded to be steered in the opposite direction).

Alternatively or additionally, the non-transitory computer-readable storage medium can include computer-executable instructions for transmitting the steering command to the tractor vehicle without adjustment in response to not detecting the jackknife condition.

The geometry of the tractor-trailer system can include a wheelbase of the tractor vehicle, a wheelbase of the trailer vehicle, and a hitch length. Additionally, the steering limit of the tractor vehicle can include at least one of a maximum steering angle or a maximum steering angular rate. Further, the articulation angle of the tractor-trailer system is a difference between a heading of the trailer vehicle and a heading of the tractor vehicle.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A is a diagram illustrating a tractor-trailer system model and control according to an implementation described herein. FIG. 1B is a diagram illustrating tractor-trailer system notations in the system shown in FIG. 1A. FIG. 1C is a diagram illustrating the maneuverability range (i.e., ψ_{M} to ψ̅_̅{̅M̅}̅) of the system shown in FIG. 1A.

FIG. 2A is a block diagram of a driver assistance system according to an implementation described herein. FIG. 2B is a flow chart illustrating example operations of a control safety governor according to implementations described herein.

FIG. 3 is an example computing device.

FIG. 4A is a graph illustrating the results of including a control safety governor (CSG-1) in the system according to an implementation described herein. FIG. 4B is a graph illustrating the results of including CSG-1 of FIG. 4A with steering rate constraints factored in.

FIG. 5 is a graph illustrating the results including a control safety governor (CSG-2) in the system according to another implementation described herein.

FIG. 6 is a flow diagram of example control safety governor module logic (i.e., CSG-2) according to an implementation described herein.

FIGS. 7A-7E are graphs illustrating path tracking results according to an implementation described herein.

FIGS. 8A-8D are graphs illustrating controller state during unfeasible turns (3^{rd} Sinusoid) according to an implementation described herein.

FIG. 9 is a flow diagram of example control safety governor module logic according to another implementation described herein.

FIG. 10 includes graphs illustrating visualization of trailer wheel paths on the tracked path for three path tracking controllers (i.e., PI, SM, and neural network) supervised by the control safety governor of FIG. 9.

FIG. 11 includes graphs illustrating path tracking controller comparisons on control command, body state, and tracking errors. In FIG. 11, the path tracking controllers were supervised by the control safety governor of FIG. 9.

FIG. 12A is a table (Table I) illustrating path tracking controller performance evaluation metrics according an implementation described herein. FIG. 12B is a table (Table II) illustrating overall comparison of path tracking controllers (i.e., PI, SM, and neural network) according an implementation described herein. In FIGS. 12A and 12B, the path tracking controllers were supervised by the control safety governor of FIG. 9.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for preventing a jackknife condition in a tractor-trailer system connected with an off-axle hitch, it will become evident to those skilled in the art that the implementations are not limited thereto.

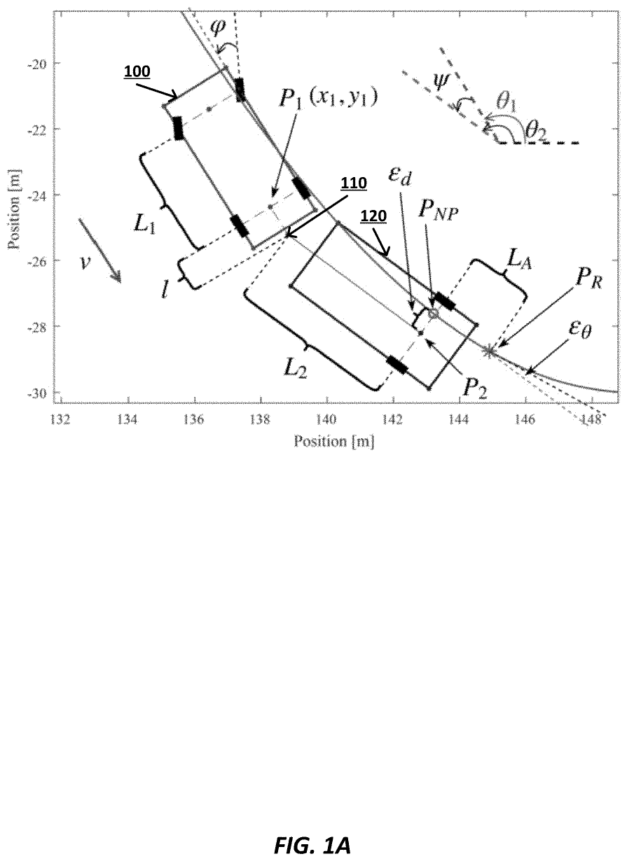

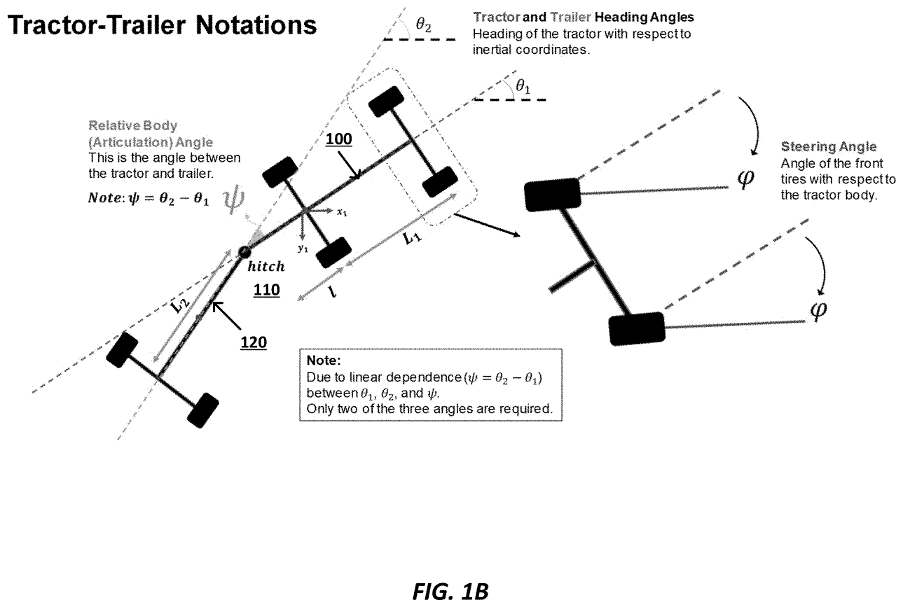

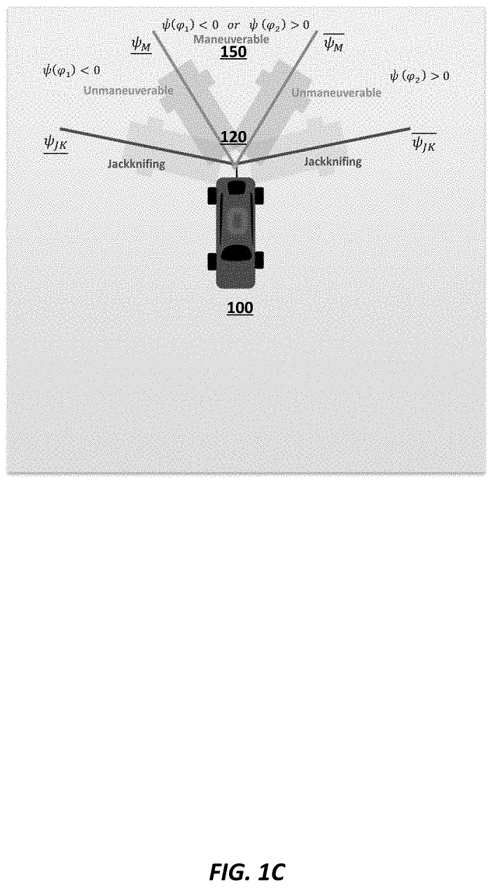

Systems and methods for preventing a jackknife condition in a tractor-trailer system are described herein. Referring now to FIGS. 1A-1C, the tractor-trailer system can include a tractor vehicle 100 and a trailer vehicle 120, where the tractor and trailer vehicles are connected via a hitch 110. In some implementations, the tractor vehicle 100 is a light-duty truck. It should be understood that the tractor vehicle 100 can be a vehicle other than a light-duty truck including, but not limited to, a car, truck, or other motorized vehicle. Additionally, the trailer vehicle 120 can optionally be a single-axle trailer. In the implementations described herein, the hitch 110 is located behind the rear bumper of the tractor vehicle 100. This is results in an off-axle tractor-trailer system.

FIG. 1C is a diagram illustrating the maneuverability range 150 of the tractor-trailer system shown in FIG. 1A. As shown in FIG. 1C, there exist relative body angles ψ_{M}, ψ̅_̅{̅M̅}̅ beyond which the magnitude of the relative body angle keeps increasing regardless of steering input. The relative body angle refers to the relative angle between the trailer vehicle 120 and the tractor vehicle 100, which is also referred to as the articulation angle (ψ). Within ψ_{M}, ψ̅_̅{̅M̅}̅, it remains possible to maneuver the trailer vehicle 120 in such a way that the relative body angle can be increased or decreased.

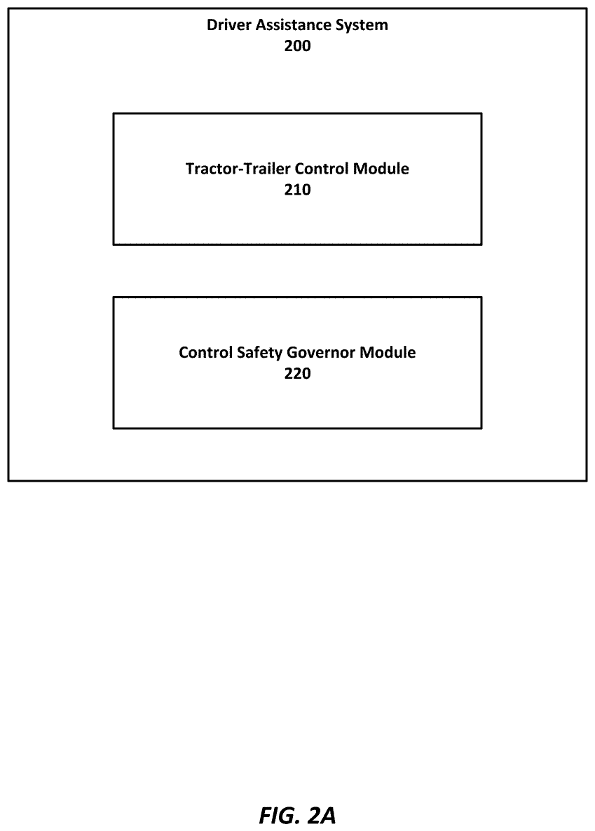

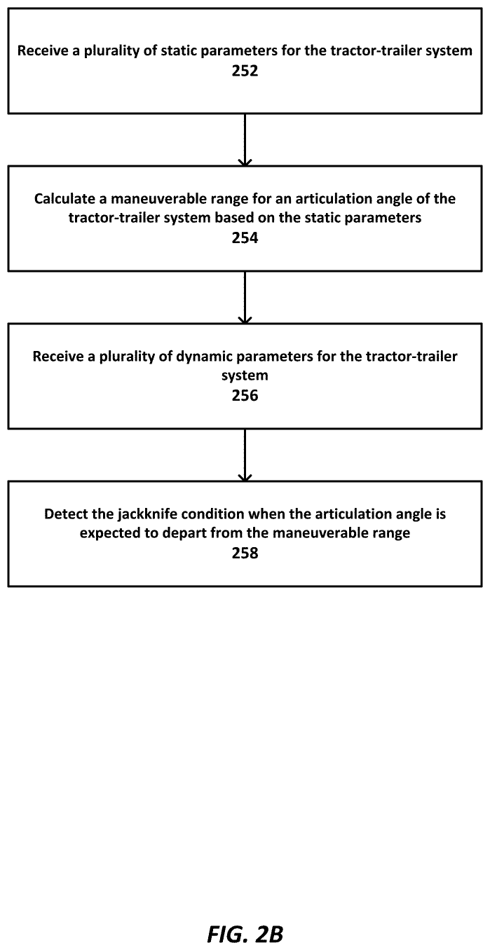

The systems and method described herein can include a driver assistance system, e.g., a driver assistance system for use with the tractor-trailer system of FIGS. 1A-1C. Referring now to FIG. 2, the driver assistance system 200 can include a tractor-trailer control module 210 and a control safety governor module 220. In some implementations, the tractor-trailer control module 210 is a path tracking module (sometimes referred to herein as “path tracking controller”), i.e., a module configured to track a trajectory of the tractor-trailer system. Path tracking controllers are capable of tracking forward and/or backward motion of a tractor-trailer system. A path tracking controller for tracking backward motion can be a proportional integral (PI) controller, a sliding mode (SM) controller, a neural network controller, a nonlinear feedback stabilization controller, a fuzzy controller, or a model predictive controller (MPC), for example. Path tracking controllers are known in the art and are therefore not described in further detail herein. Although a path tracking controller is provided as an example, this disclosure contemplates that the tractor-trailer control module 210 can be any controller configured to steer the tractor vehicle's wheel(s) (e.g., the front wheels of the tractor vehicle) to keep the system driving on a given reference trace including, but not limited to, an autonomous parking controller or an autonomous vehicle controller.

Additionally, the control safety governor module 220 can be configured to supervise the tractor-trailer control module 210 to prevent occurrence of the jackknife condition. For example, the control safety governor module 220 can be configured to adjust a steering command generated by the tractor-trailer control module 210 in response to detecting the jackknife condition.

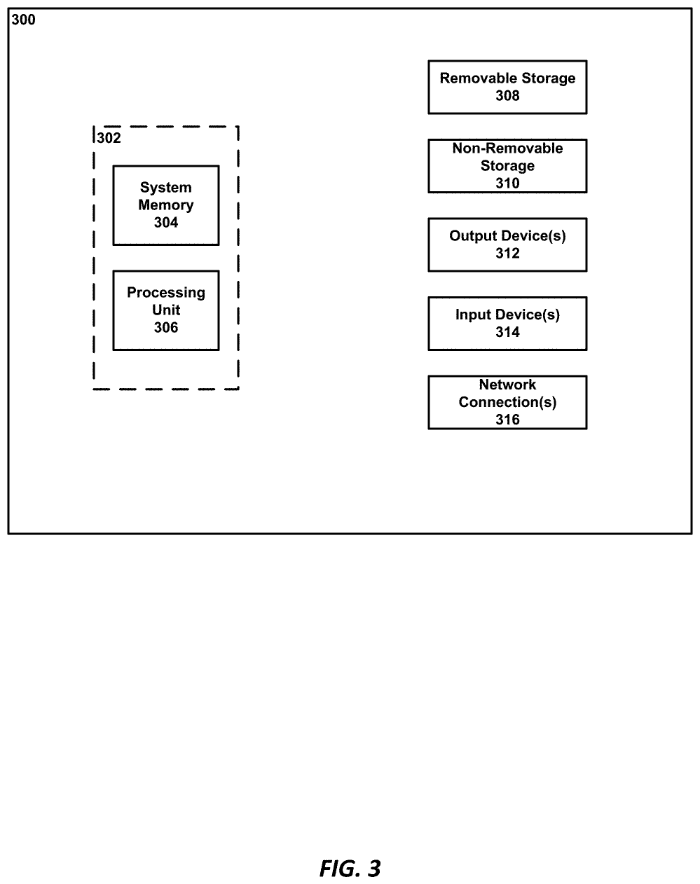

Referring now to FIG. 2B, example operations of a control safety governor (e.g., control safety governor module 220 of FIG. 2A) are described. The control safety governor can prevent a jackknife condition from occurring in a tractor-trailer system (e.g., the tractor-trailer system including the tractor vehicle 100 and the trailer vehicle 120 of FIGS. 1A-1C). As described herein, this disclosure contemplates that the operations of FIG. 2B can be implemented in connection with hardware or software or, where appropriate, with a combination thereof. In some implementations, the control safety governor can optionally be computer-executable instructions stored in memory that, when executed by a computing device (e.g., computing device 300 of FIG. 3), cause the computing device to perform the operations. Optionally, the control safety governor can be a plug-in, e.g., a module adding specific functionality to existing software/controller such as a tractor-trailer control module (e.g., tractor-trailer control module 210 of FIG. 2A).

At step 252, a plurality of static parameters for the tractor-trailer system are received. The static parameters can include a geometry of the tractor-trailer system and a steering limit of the tractor vehicle. The geometry of the tractor-trailer system can include a wheelbase (e.g., tractor wheelbase L1 in FIGS. 1A-1B) of the tractor vehicle, a wheelbase (e.g., trailer wheelbase L2 in FIGS. 1A-1B) of the trailer vehicle, and a hitch length (e.g., hitch length/in FIGS. 1A-1B). Additionally, the steering limit of the tractor vehicle can include at least one of a maximum steering angle (e.g., steering angle (φ) in FIGS. 1A-1B, where φ is bounded by φ∈(φ, φ̅)) or a maximum steering angular rate. In some implementations, the steering limit of the tractor vehicle can include both the maximum steering angle and the maximum steering angular rate. It should be understood that the static parameters are fixed for a given tractor-trailer system, e.g., the static parameters do not change during system operation.

At step 254, a maneuverable range for an articulation angle of the tractor-trailer system is calculated based on the static parameters. The articulation angle (ψ) of the tractor-trailer system is a difference between a heading of the trailer vehicle (e.g., trailer heading (θ₂) in FIG. 1B) and a heading of the tractor vehicle (e.g., tractor heading (θ₁) in FIG. 1B). The maneuverable range is the range of relative vehicle body angles (or articulation angles (ψ)) where it is possible to maneuver the trailer vehicle such that the articulation angle (ψ) can be increased or decreased. The maneuverable range is bounded by ψ∈(ψ_{M}, ψ̅_̅{̅M̅}̅) (e.g., as shown by FIG. 1C). The maneuverable range can be calculated using Eqns. (30) and (31) below.

At step 256, a plurality of dynamic parameters for the tractor-trailer system are received. The dynamic parameters can include a steering command from a tractor-trailer controller, a longitudinal speed of the tractor vehicle, and a measured articulation angle of the tractor-trailer system. As described herein, the control safety governor can supervise the tractor-trailer controller (e.g., tractor-trailer control module 210 in FIG. 2A) such as a path tracking controller, for example. The tractor-trailer controller generates steering commands (e.g., steering angle (φ) and/or steering angular rate), which are transmitted to a steering actuator of the tractor vehicle, for example, to maintain the tractor-trailer system on a given reference path. This disclosure contemplates that such steering commands can be received by the control system governor. Additionally, the control system governor can receive the longitudinal speed (e.g., longitudinal speed (v) in FIG. 1A) of the tractor vehicle, which is the speed in the direction of backward travel, from the tractor vehicle. Further, the control system governor can receive the measured articulation angle (ψ) of the tractor-trailer system. The measured articulation angle is the current, real-time articulation angle (ψ). This disclosure contemplates that the articulation angle (ψ) can be measured by a camera-based system and/or articulation state system (e.g., a combination of steering wheel angle, acceleration, yaw, and/or axle load sensors). Camera-based and articulation state systems are provided only as example systems for measuring articulation angle (ψ), and this disclosure contemplates using a system other than camera-based and articulation state systems to measure articulation angle.

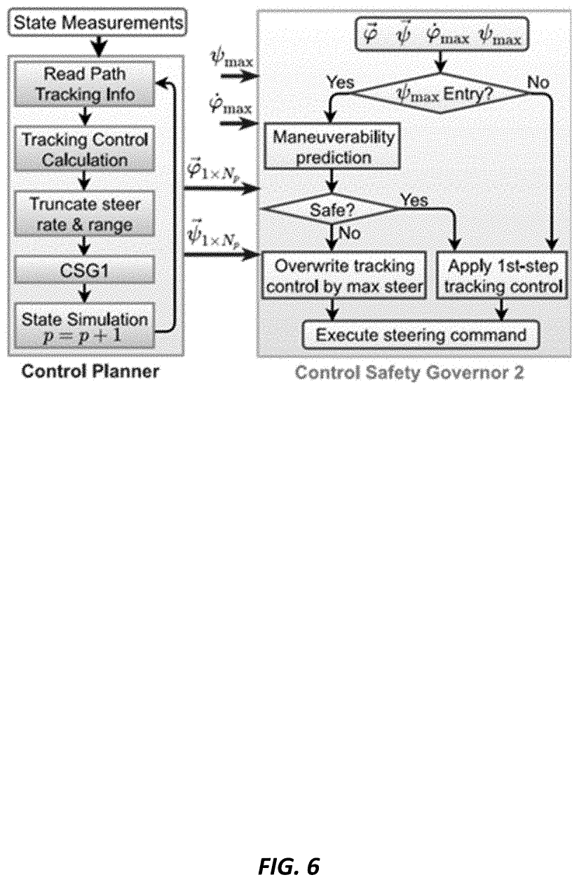

At step 258, the jackknife condition is detected when the articulation angle is expected to depart from the maneuverable range. In some implementations, the step of detecting the jackknife condition when the articulation angle is expected to depart from the maneuverable range includes approximating a kinematic model for the tractor-trailer system. Example kinematic models for the tractor trailer system are shown by Eqns. (1a-1c) and Eqns. (29a-29e) below. The kinematic model for the tractor-trailer system can be approximated under a maximum steering rate condition for the tractor vehicle. Example logic is shown by FIG. 6. Optionally, the step of detecting the jackknife condition when the articulation angle is expected to depart from the maneuverable range can further include deriving an analytical equation from the approximation of the kinematic model for the tractor-trailer system under the maximum steering rate condition for the tractor vehicle. In these implementations, the control safety governor accounts for the fact that the tractor vehicle's steering system cannot respond instantaneously to steering commands. As such, the control safety governor can ensure that the system is capable of responding with maximum steering angle and/or maximum steering angular rate in time to prevent the jackknife condition.

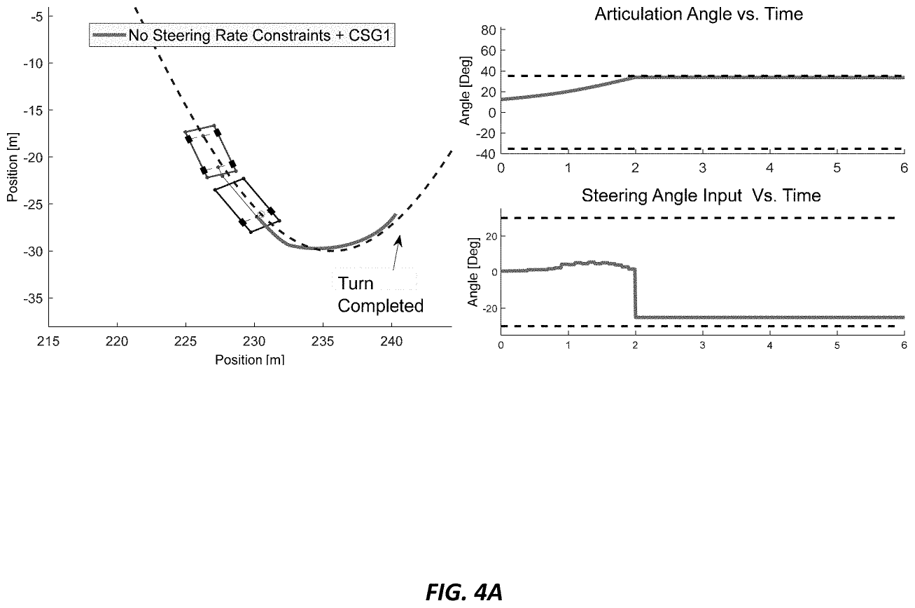

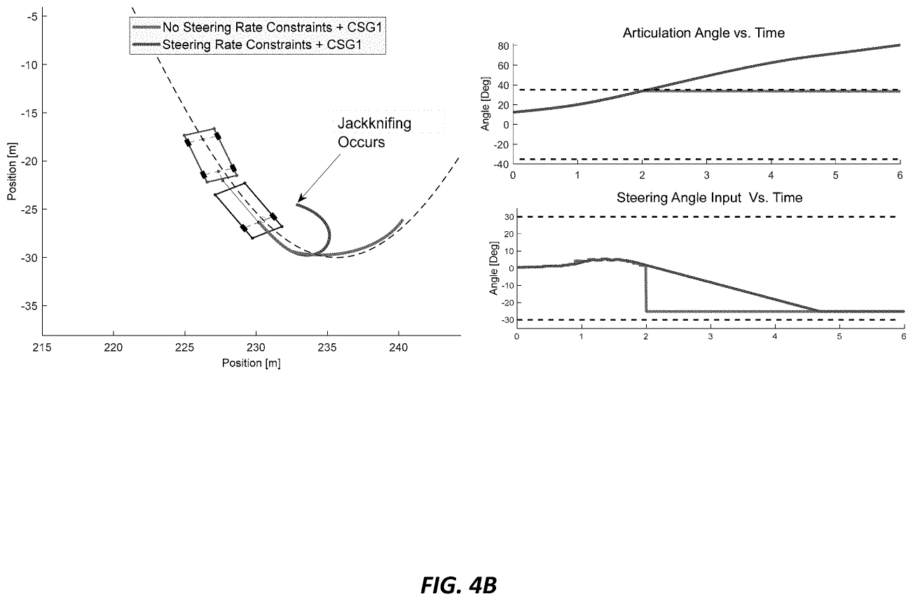

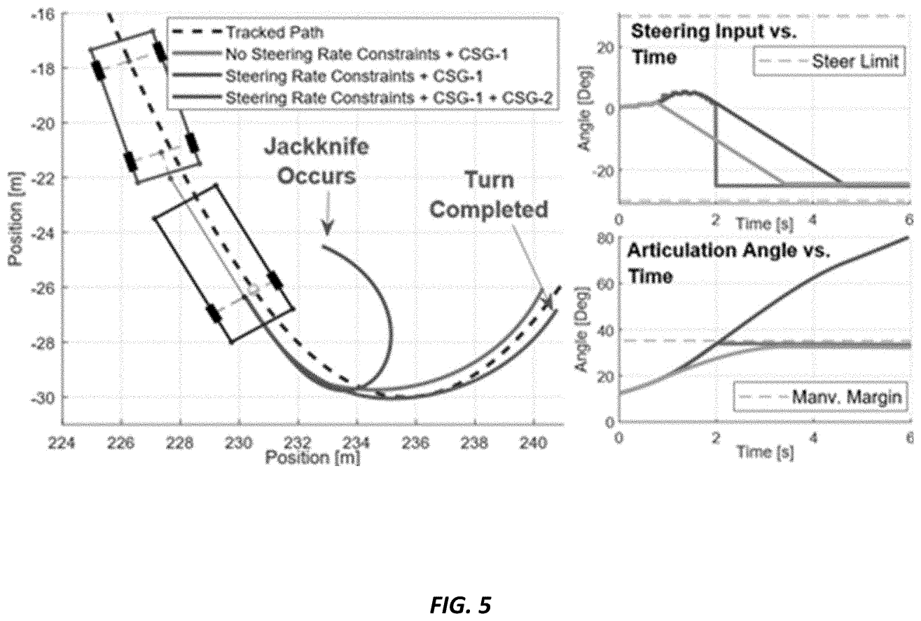

In FIGS. 4A-5, various control safety governors are compared. The control safety governor of FIG. 5 (CSG-2) is approximated under maximum steering rate conditions such that CSG-2 is capable of preventing jackknifing under all conditions. This is in comparison to CSG-1 of FIGS. 4A (steering constraints ignored) and 4B (steering constraints factored in). In particular, FIG. 4A is a graph illustrating the results of including a control safety governor (CSG-1) in a tractor-trailer system. Maneuverability is ensured by putting in place the CSG-1, which overrides the current control input to keep the articulation angle within a range ψ∈(ψ_{M}, ψ̅_̅{̅M̅}̅). At unfeasible turns, CSG-1 is activated to hold the upper limit of the articulation angle under the maneuverability conditions. For example, at time=2, ψ is detected to exceed ψ̅_{CSG} (near ψ̅_̅{̅M̅}̅), and CSG-1 instantly switches the steering angle to a value that maintains the relative body angle until turn completion. This ensures system does not lose maneuverability during turn (eventually jackknifing). CSG-1 disengages upon completion of turn. It should be understood, however, that steering angle cannot be switched instantaneously in practice. FIG. 4B is a graph illustrating the results of including CSG-1 of FIG. 4A with steering rate constraints factored in. Under bounded steering rate, ensuring system maneuverability cannot be achieved by solely using CSG-1. CSG-1 demands that a steering value which ensures system maneuverability be instantaneously implemented. However, this is not practical since unrealistic steering rates can be demanded under certain circumstances. For example, at time=2, even though ψ is detected to exceed ψ̅_{CSG} (near ψ̅_̅{̅M̅}̅), steering constraints means that instant switching performed by CSG-1 is not possible (i.e., steering angle decreases linearly over time between time=2 and time=4.5). As a result, articulation angle exceeds the maneuverability (ψ>ψ̅_̅{̅M̅}̅) range before steering can reach φ_{CSG}. At that point, the articulation angle keeps increasing until jackknifing occurs.

On the other hand, FIG. 5 is a graph illustrating the results including a control safety governor (CSG-2) in a tractor-trailer system. FIG. 5 shows the unfeasible turn execution using CSG1, as well as CSG1+CSG2 under constrained and unconstrained steering rates. CSG-2 uses only the current articulation angle, and the current steering. It is possible to determine if maneuverability will be violated. CSG-2 only takes over at the time-step it is absolutely necessary to do so (e.g., minimal interference). Additionally, state trajectory is obtained using analytical equations rather than iterative ones. This makes for very efficient computation suitable for real-time applications (e.g., <5 milliseconds (ms) for decision versus about 200 ms using computational techniques). When steering rate constraints are considered, steering starts earlier (i.e., at time <1) to ensure maneuverability. As shown in FIG. 5, CSG-2 ensures that the system initiates steering to φ_{CSG} such that within the time it takes to reach that value under steering rate constraints, the articulation angle remains within the maneuverable range (ψ<ψ_{CSG} ∀t).

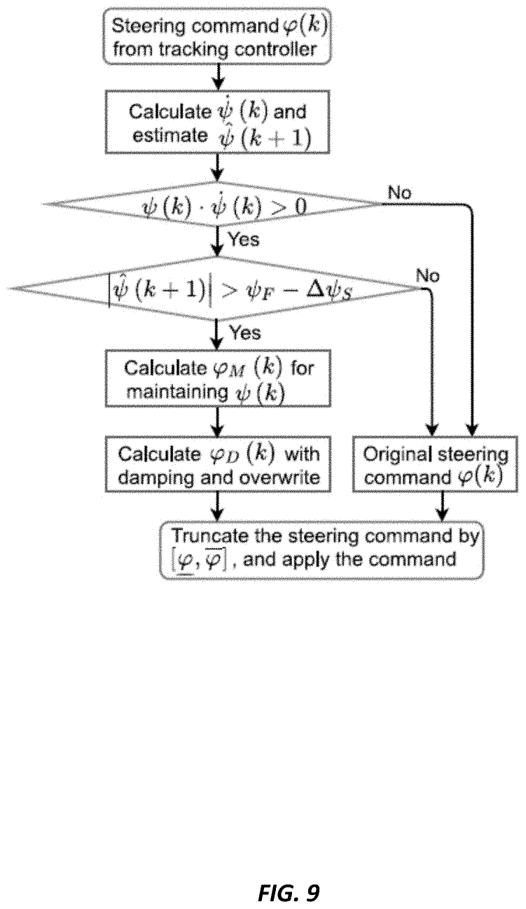

In other implementations, the operations can include calculating an expected articulation angle of the tractor-trailer system based on the dynamic parameters, and determining whether the expected articulation angle is within the maneuverable range. This is shown by the logic of FIG. 9, for example. The jackknife condition can be detected when the expected articulation angle is outside of the maneuverable range. In this implementation, the expected articulation angle of the tractor-trailer system can be calculated using a kinematic model for the tractor-trailer system. As described above, an example kinematic model for the tractor trailer system is shown by Eqns. (1a-1c) and Eqns. (29a-29e) below. Optionally, an analytical equation can be derived from an approximation of the kinematic model for the tractor-trailer system.

Optionally, in some implementations, the operations can include adjusting the steering command (e.g., steering angle (φ) and/or steering angular rate) in response to detecting the jackknife condition, and transmitting the adjusted steering command to the tractor vehicle (e.g., to the steering actuator of the tractor vehicle). The step of adjusting the steering command can include adjusting a commanded steering angle for the tractor vehicle (e.g., a magnitude and/or a direction of the steering angle (φ)). For example, in some implementations, the magnitude of the commanded steering angle (φ) can be reduced. In other implementations, the magnitude of the commanded steering angle (φ) can be initially reduced and then eventually increased to a commanded steering angle with opposite sign. In yet other implementations, the magnitude of the commanded steering angle (φ) can be initially reduced and then eventually increased to a magnitude greater than initial commanded steering angle but with opposite sign. Alternatively or additionally, the step of adjusting the steering command can include adjusting a commanded steering angular rate for the tractor vehicle. For example, in some implementations, the magnitude of the steering angular rate can be increased and/or decreased relative to initial steering angular rate.

Optionally, in some implementations, the operations can include transmitting the steering command to the tractor vehicle without adjustment in response to not detecting the jackknife condition.

It should be appreciated that the logical operations described herein with respect to the various figures may be implemented (1) as a sequence of computer implemented acts or program modules (i.e., software) running on a computing device (e.g., the computing device described in FIG. 3), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by dashed line 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

### Example 1

Jackknifing during tractor-trailer reverse driving presents a major challenge in control system design. In this paper, maneuverability conditions were explicitly derived for tractor-trailer systems that are hitched off-axle. A control safety governor was designed and constructed to guarantee that the system stays within the derived maneuverability conditions under steering rate constraints using any controller. The control safety governor is decoupled from the controller so that it can be used in a plug-in fashion with minimal interference. The performance of the designed system was tested for a neural network controller on an increasingly rigorous path with introduced discontinuities. Results show that the system was able to successfully track the path without jackknifing. This example provides a solution that is capable of guaranteeing jackknife prevention for any reverse path tracking controller for tractor-trailer systems.

### I. Introduction

Backward maneuvering and parking of tractor-trailers presents a challenge to most drivers since the tractor's steering wheel does not directly affect the trailer's direction. Adding to the complexity of the problem, the tractor and trailer may collide with each other, known as jackknifing, when the articulation angle between them is large enough. There are strong efforts in automating the parking process of vehicles hitched with trailers as vehicles trend toward increased autonomy, of which path tracking control is a core function in the development. The path tracking control method for tractor-trailer backwards motion encounters additional challenges and restrictions: articulated vehicles are underactuated systems with unstable internal dynamics containing highly coupled nonlinear terms, and they are not differentially flat when hitched off-axle.

Although there is a considerable amount of existing research on path tracking for articulated vehicles, a large majority of the work focuses only on handling the unconstrained tractor-trailer path tracking problem. Little attention is paid to incorporating constraints such as the tractor vehicle's maximum steering angle range, rate, and the state bound of maximum articulation angle for safety. A wide range of techniques have been developed for unconstrained tractor-trailer backward path tracking controller design. Simple control methods that utilize PI control have been successfully implemented with coordinate transformations to handle system nonlinearity [1], [2]. Based on stability analysis, there are path tracking methods including feedback linearization [3], nonlinear feedback stabilization [1], [4] [6], fuzzy control [7], [8], and backstepping control [9], all of which have all been proven to be effective for both forward and backward driving. Creating a virtual forward driving tractor [10], [11] is another technique used to reduce the complexity in handling system stability and is usually combined with feedback linearization. Model predictive control is a popular technique often selected for handling constraints on steering and articulation angles [12]-[14], however the computational load can be intensive and it requires model simplification. Neural network approaches have also been proposed for the complex tractor-trailer systems [15], [16].

Among the above reviewed studies, only a few investigate conditions for occurrence of jackknife accidents and develop controllers designed to avoid jackknifing during backward motion [4]-[6], [13], [14]. Existing control designs also lack compliance with both steering and steering rate constraints. The only literature found addressing this issue is [1], where the authors discover that steering rate limit can cause failure in a path tracking controller designed without such a constraint. Bound handling by the aforementioned work is done by gain tuning with the existence of a steering rate limit, and jackknifing in backward motion is not prevented by such a method. There is a gap in literature over tractor-trailer path tracking controllers that can ensure jackknife-free operation under steering and steering rate constraints.

This example examines the safety of articulated vehicles in backward motion and determines the maneuverable range beyond which jackknifing is inescapable given the tractor's steering capability. A Control Safety Governor (CSG) is proposed for tractor-trailer backward path tracking, which ensures jackknife prevention under the tractor's steering and steering rate limits. A neural network path tracking controller is also designed and trained with the CSG to learn a near-optimal control policy in the context of the imposed bounds.

### II. System Model

The model used for tractor-trailer vehicle lateral control is constructed from a double bicycle model [17], [18]. The tractor-trailer system studied has an off-axle hitch behind the tractor rear bumper, and the trailer has a single axle. Notation of parameters related to the model and control calculations is illustrated in FIG. 1A, where the upper (red) and lower (blue) vehicles refer to the tractor and trailer respectively. Parameters defining the steering geometry include the tractor's wheelbase L₁ measured between the front and rear axles, the hitch length l measured from the tractor rear axle to the hitch joint, the trailer's wheelbase L₂ measured between the hitch joint and the trailer's axle, and the tractor's longitudinal speed v. State parameters include the tractor and trailer heading angles θ₁ and θ₂, and articulation angle ψ=θ₂−θ₁. Lateral tracking control is applied by the tractor's front wheel steering angle φ, bounded by φ∈[φ, φ̅] and with steering rate φ bounded by \dot{φ}∈[\dot{φ}, \dot{φ̅}]. Defining (x, y) as the position of the tractor vehicle's rear axle center P₁ in Earth coordinates, the control system model is:)

\dot{x}=v cos φ cos θ₁ \dot{y}=v cos φ sin θ₁ (1a)

\dot{ψ}=−v(L₂ tan(φ)+L₁ sin(ψ)−l tan(φ)cos(ψ))/L₁L₂ (1b)

\dot{θ}₂=−v(L₁ sin(ψ)−l tan(φ)cos(ψ))/L₁L₂ (1c)

For the objective of maintaining the trailer on the path to be tracked, the control reference variables are defined by the trailer's axle center using distance and direction errors. Denote P_{NP} as the nearest point from the trailer axle center P₂ to the tracked path, the distance in between is the lateral distance tracking error ε_{d}, with the right-hand side of driving direction defined as positive error. The angular difference between the trailer's heading angle and the tangent line at P_{NP} is defined as the actual heading angle tracking error, calculated as ε_{θnp}=θ_{P}_{_{NP}}−θ₂. To foresee upcoming turns in the path, a reference point P_{R} is defined with a look ahead distance L_{A} along the path ahead of P_{NP}. The angular difference between the trailer's heading angle and the tangent line at P_{R} is defined as the reference heading angle tracking error, calculated as ε_{θ}=θ_{P}_{_{R}}−θ₂. In this work, the anticlockwise direction is denoted as positive for all angular variables. Tracking control is designed to minimize only the trailer's tracking error because the system has only one degree of freedom in control (the tractor's steering).

### III. Maneuverability and Control Safety Governor Design

Maneuverability for tractor-trailer systems refers to having the ability of both increasing (\dot{ψ}>0) and decreasing (\dot{ψ}<0) the system articulation angle ψ using values within the steering range bounds [φ, φ̅].

Definition: The system is said to be maneuverable within a maneuverability range (ψ_{M}, ψ̅_{M}) if ∀ψ∈(ψ_{M},ψ̅_{M}),∃φ₁,φ₂∈[φ, φ̅]|\dot{ψ}(φ₁)>0,\dot{ψ}(φ₂)<0.

A. Maneuverability Conditions under Saturated Steering

Proposition 1:

For a tractor-trailer system with an off-axle hitch, the system remains maneuverable as long as the articulation angle remains within the range (ψ_{M}, ψ̅_̅{̅M̅}̅), where

$$\begin{matrix}\underline{{ψ}_{M}} = arctan 2 ( {L}_{1} , - l tan \overline{ϕ} ) - {cos}^{- 1} ( - \frac{tan \overline{ϕ}}{[ {( l / {L}_{2} tan \overline{ϕ} )}^{2} + {( - {L}_{1} / {L}_{2} )}^{2} ]} ) & ( 2 ) \\ \overline{{ψ}_{M}} = arctan 2 ( {L}_{1} , - l tan \underline{ϕ} ) - {cos}^{- 1} ( - \frac{tan \underline{ ϕ}}{[ {( l / {L}_{2} tan \underline{ ϕ} )}^{2} + {( - {L}_{1} / {L}_{2} )}^{2} ]} ) & ( 3 ) \\ Proof \text{:} & \\ Setting u ( ϕ ) := ( \frac{v}{{L}_{1}} ) tan ϕ & \\ \dot{ψ} = u ( ϕ ) ( \frac{l}{{L}_{2}} cos ( ψ ) - 1 ) - \frac{v sin ψ}{{L}_{2}} & ( 4 )\end{matrix}$$

ψ_{M} is the first value for ψ<0 for which the system is no longer maneuverable under minimal saturated steering input where ψ_{M}: {max(ψ) ∀ψ<0|φ∈[(φ, φ̅],\dot{ψ}≤0}, and max (ƒ(ψ_{M},φ))=0, where ƒ(ψ,φ) is a function representing the body angle rate defined by the right hand side of (1b).

Assuming that l<L₂, which is the case for tractor-trailers in practice, it is clear that for a ψ:|ψ|<π/2, \dot{ψ} is a decreasing function of u(φ).

So, max ƒ(ψ_{M},φ)=ƒ(ψ_{M}, u⁻¹(min u(φ)))=0.

For φ:

$$\vert φ \vert < \frac{π}{2} ,$$

u(φ) is a decreasing function of φ. This implies that min(u(φ))=u(φ̅). So, ƒ(ψ_{M},φ̅)=0. Using (1b), and rearranging some terms,

$$- v sin \frac{( {\underline{ψ}}_{M} )}{{L}_{2}} + u ( \overline{ϕ} ) l cos ( {\underline{ψ}}_{M} ) / {L}_{2} = u ( \overline{ϕ} ) \qquad ( 5 )$$

Constructing a right-angle triangle with an angle α and a hypotenuse M such that tan α:=(−v/L₂)/(u(φ̅)(l/L₂)) and M:=((−v/L₂)\hat{ }2+(u(φ̅)(l/L₂)\hat{ }2)^{-1/2}, it becomes clear that

$$- ( \frac{v}{{L}_{2}} ) = M sin α and u ( \overline{ϕ} ) ( \frac{l}{{L}_{2}} ) = M cos α .$$

Substituting in (5) and using trigonometric identities,

$$\begin{matrix}M sin αsin {\underline{ψ}}_{M} + M cos αcos {\underline{ψ}}_{M} = u ( \overline{ϕ} ) & ( 6 a ) \\ cos ( α - {\underline{ψ}}_{M} ) = u ( \overline{ϕ} ) / M & ( 6 b ) \\ {\underline{ψ}}_{M} = α - {cos}^{- 1} ( \frac{u ( \overline{ϕ} )}{M} ) & ( 6 c )\end{matrix}$$

Substituting the values of M and a in the previous equations, the expression in (2) is obtained. (3) is similarly derived.

Once (ψ_{M}, ψ̅_{M}) is exceeded, the system approaches ψ=π for any steering input within the range [φ, φ̅]. The only way that the system can recover is either to come to a complete stop before jackknifing occurs, or shift to forward driving and then drive forward until ψ∈(ψ_{M}, ψ̅_{M}). The vehicle then needs to stop again and shift back to reverse driving, which is inefficient. Ensuring that the system remains within the maneuverable range (ψ_{M}, ψ̅_{M}) at all times during reverse driving eliminates the need to switch to forward driving to prevent jackknifing. It is therefore of importance that a safety governor be implemented to ensure the system obeys maneuverability conditions under any implemented control system. The implemented safety governor is the CSG detailed in this paper, consisting of two parts referred to as CSG-1 and CSG-2.

B. Control Safety Governor Design 1

CSG-1 ensures that the system does not violate a set [ψ_{CSG}, ψ̅_{CSG}]⊂(ψ_{M}, ψ̅_{M}) based on steering angle constraints (φ)∈[φ, φ̅] with \dot{φ}∈(−∞, ∞). Once the articulation angle reaches ψ_{CSG} or ψ̅_{CSG}, CSG-1 switches steering to φ̅_{CSG} or φ_{CSG} such that \dot{ψ}=0 in order to keep the articulation angle within the maneuverability range. CSG-1 can be summarized through (7),

$$ϕ = \{ \begin{matrix}{ϕ}_{controller} \\ {\overline{ϕ}}_{CSG} \vert \dot{ψ} = 0 , ψ = {\underline{ψ}}_{CSG} \\ {\underline{ϕ}}_{CSG} \vert \dot{ψ} = 0 , ψ = {\overline{ψ}}_{CSG}\end{matrix} \qquad ( 7 )$$

CSG-1 is demonstrated with no constraints on steering rate by the magenta trajectories in FIG. 5, which shows the execution of a turn that the system is unable to perfectly track due to non-holonomic and geometrical constraints. The system initially tracks the path using the steering angle generated from an implemented path tracking controller. Once ψ=ψ̅_{CSG}, switching is immediately made to φ_{CSG} as indicated in (7) such that \dot{ψ}=0. This holds the current articulation angle until the system executes the unfeasible turn. The steering input takes the values issued by the controller once ψ returns to the maneuverable range. There is a sudden switch of the steering angle command upon activation of CSG1 under the implementation in FIGS. 4A-5 in the unconstrained steering rate case. Since steering rate is constrained in the real world, CSG-1 in its current form is not practical to implement. When a constraint is imposed on the steering rate, the system may not be able to react quickly enough to reach the required steering input so that maneuverability can be guaranteed (e.g., as shown in FIGS. 4A-5). This leads to ψ possibly exceeding the maneuverability range (ψ_{M}, ψ̅_{M}). An example of such a scenario can be seen by the red trajectory in FIGS. 4A-5.

C. Maneuverability Conditions Under Saturated Steering and Steering Rate

Conditions must be set to ensure system maneuverability under bounded steering rate inputs. Enforcement of these conditions is handled by CSG-2. For the case depicted by the red trajectories in FIG. 5, earlier action needs to be taken to ensure that φ=φ̅ before ψ=ψ_{M}. In other words, it is required that the articulation angle remains in the range of (ψ_{M}, ψ̅_{M}) within the time required for the steering angle to reach its maximum value φ=φ̅. More formally, these conditions can be stated as follows:

tᵤ₁:∫ₜ_{₀}^{t}^{ᵤ₁}\dot{φ}dt+φ(t₀)=φ (8a)

tᵤ₂:∫ₜ_{₀}^{t}^{ᵤ₂}\overline{\dot{φ}}dt+φ(t₀)=φ̅ (8b)

To ensure maneuverability, it is necessary that,

∫ₜ_{₀}^{tu1}\dot{ψ}(φ,ψ)dt+ψ(t₀)<ψ̅_{M} (8c)

∫ₜ_{₀}^{tu2}\dot{ψ}(φ,ψ)dt+ψ(t₀)>ψ_{M} (8d)

Satisfaction of the above conditions at all times ensures system maneuverability under steering rate constraints. However, it is not trivial to obtain (8c) and (8d) due to difficulties finding an analytic solution for this integral. Sufficient conditions will be derived as follows to ensure maneuverability based on (8a) and (8c) in a practically efficient manner.

Proposition 2:

Consider a tractor-trailer system with a current articulation angle ψ₀∈(ψ_{M}, ψ̅_{M}), a current steering angle φ₀, a steering angle constrained by φ∈[φ, φ̅], and a steering angle rate constrained by \dot{φ}∈[\dot{φ}, \overline{\dot{φ}}].

The tractor-trailer system remains maneuverable if ψ₂ (tᵤ_{₁})<ψ̅_̅{̅M̅}̅ and ψ₂ (tᵤ_{₁})>ψ_{M} where

$$\begin{matrix}{ψ}_{2} ( {t}_{u} ) = {\sum }_{k = 0}^{K - 1} [ {ψ}_{2 k} ( ( k + 1 ) Δ t ) - {ψ}_{2 k} ( k Δ t ) ] + ψ ( {t}_{0} ) & ( 9 ) \\ {ψ}_{2 k} ( t ) = - i ln \{ \frac{[ - {n}_{k} - {iM}_{k} tan ( ( \frac{{M}_{k}}{2} ) ( {C}_{k} + t ) ) ]}{2 {l}_{k} - 2 {im}_{k}} \} & \end{matrix}$$

K∈ [symbol] such that K:=tᵤ/Δt, Δt is selected to be arbitrarily small; tᵤ∈{tᵤ_{₁},tᵤ_{₂}}, with tᵤ_{₁}:=|(φ−φ₀)/\dot{φ}|, tᵤ_{₂}=|(φ−φ₀)/\overline{\dot{φ}}|; lₖ:=vlu(kΔt)/2(L₁L₂), mₖ:=−v/(2L₂), nₖ:=−vu(kΔt)/L₁, Mₖ:=(−4lₖ²−4mₖ²+nₖ²)^{1/2}; Cₖ=2Mₖ⁻¹ tan⁻¹[(e^{iψ}^{₂}^{(kΔt)}(2lₖ−2imₖ)+nₖ)/−iMₖ].

Proof:

The following proof is for the sufficient conditions that ensure system maneuverability based on (8a) and (8c). For an initial time t₀ and an arbitrary time t such that t₀≤t≤tᵤ_{₁}, the steering under maximum control effort is

φ(t)=∫ₜ_{₀}^{t}\dot{φ}dt+φ(t₀) (10)

Noting that \dot{φ} is a constant value,

φ(t)=(\dot{φ})(t−t₀)+φ(t₀) (11)

Substituting (11) in (1b) and rearranging the terms,

\dot{ψ}(t)=tan((\dot{φ})(t−t₀)+φ(t₀))(vl cos(ψ(t))−vL₂)/L₁L₂−v sin(ψ(t))/L₂ (12)

Let u(t):=tan ((\dot{φ})(t−t₀)+φ(t₀)), substituting in (12),

\dot{ψ}(t)=u(vl cos(ψ(t)−vL₂)/L₁L₂−v sin(ψ(t)/L₂ (13)

Let ψ₂ be a function that is constructed such that \dot{ψ}₂>\dot{ψ}₁ and ψ₂(t₀)=ψ₀. Conditions in (8c) can now be relaxed to

∫ₜ_{₀}^{t}^{ᵤ₁}\dot{ψ}(t)dt+ψ(t₀)≤∫ₜ_{₀}^{t}^{ᵤ₁}\dot{ψ}₂(t)dt+ψ(t₀)<ψ̅_{M} (14)

It is assumed that trailers with |l/(L₁L₂)|<|1/L₁| are considered (wheelbase of the trailer L₂ needs to be longer than the hitch l), which is generally the case. A function \dot{ψ}₂(t) is constructed with the following form:

\dot{ψ}₂(t):=u₂(t)(vl cos(ψ(t))−vL₂)/L₁L₂−v sin(ψ(t))/L₂ (15)

Function construction takes several steps. In the first step, a function u₂(t) is defined as a staircase function uniformly partitioned every Δt over the interval [t₀, tᵤ_{₁}]. A general staircase function u₂(t) is defined in (16),

u₂(t)={aₖ|aₖ∈ [symbol] ,k∈ [symbol] ,kΔt∈[t₀,tᵤ_{₁}]} (16)

A value aₖ assigned to each of the partitions (each step in the staircase) that ensures \dot{ψ}₂>\dot{ψ}₁(t). Without a loss of generality, set t₀=0. Let Δt be selected to be arbitrarily small and K to be selected such that KΔt=tᵤ_{₁}, where K∈ [symbol] . aₖ:=u(kΔt) >u(t) for all intervals [kΔt, (k+1)Δt]. This function ensures that \dot{ψ}₂>\dot{ψ}₁(t).

u₂={u(kΔt)|k∈{0,1, . . . ,K},kΔt∈[0,tᵤ_{₁}]} (17)

A sufficient condition for system maneuverability is ∫ₜ_{₀}^{t}^{ᵤ₁}\dot{ψ}₂(t)dt+ψ(t₀)<ψ̅_{M} as seen from (14). ∫ₜ_{₀}^{t}^{ᵤ₁}\dot{ψ}₂(t)dt is analytically obtained. Expanding the integral to a sum of the intervals, where each interval sets the initial conditions for the next and is defined based on the steps in the staircase function u₂(t) in (16),

$${{\int }_{0}}^{{t}_{u 1}} {\dot{ψ}}_{2} ( t ) dt = {\sum }_{k = 0}^{K - 1} {{\int }_{k Δ t}}^{( k + 1 ) Δ t} u ( k Δ t ) \frac{( vl cos ( ψ ( t ) ) - {vL}_{2} )}{{L}_{1} {L}_{2}} - \frac{v}{{L}_{2}} sin ( ψ ( t ) ) dt \qquad ( 18 )$$

Fie each interval [kΔt, (k+1)Δt] in (18), define

$$\begin{matrix}{\dot{ψ}}_{2 k} ( t ) := u ( k Δ t ) \frac{( vl cos ( ψ ( t ) ) - {vL}_{2}}{{L}_{1} {L}_{2}} - \frac{v}{{L}_{2}} sin ( ψ ( t ) ) & ( 19 ) \\ let , {l}_{k} := \frac{vlu ( k Δ t )}{2 ( {L}_{1} {L}_{2} )} , {m}_{k} := - \frac{v}{2 {L}_{2}} , {n}_{k} := - \frac{vu ( k Δ t )}{{L}_{2}} then , & \\ {\dot{ψ}}_{2 k} = 2 {l}_{k} cos ( {ψ}_{2} ) + 2 {m}_{k} sin ( {ψ}_{2} ) + {n}_{k} & ( 20 )\end{matrix}$$

Using Euler's angle formulas,

\dot{ψ}₂ₖ=e^{iψ}^{₂}(lₖ−imₖ)+e−^{iψ}^{₂}(lₖ+imₖ)+nₖ (21)

The generalized solution of the differential equation (21) is,

$${ψ}_{2 k} ( t ) = - i ln \{ \frac{[ - {n}_{k} - {iM}_{k} tan ( ( \frac{{M}_{k}}{2} ) ( {C}_{k} + t ) ) ]}{2 {l}_{k} - 2 {im}_{k}} \} \qquad ( 22 )$$

where Mₖ:=(−4lₖ²−4mₖ²+nₖ²)^{1/2}, and Cₖ are obtained from the initial boundary conditions. At each interval, the initial boundary condition is ψ₂(kΔt), which is obtained from the solution of the previous interval. The initial boundary condition for the first interval is set to the current articulation angle ψ₂(0)=ψ₀. Even though imaginary terms are included in (21), the solution is in fact a real number. Solving for Cₖ based on the boundary condition ψ₂(kΔt), and (22):

Cₖ=2Mₖ⁻¹ tan⁻¹[(e^{iψ}^{₂}^{(kΔt)}(2lₖ−2imₖ)+nₖ)/−iMₖ] (23)

substituting (22) in (18),

∫₀^{t}^{ᵤ₁}\dot{ψ}₂(t)dt=Σₖ₌₀^{K-1}[ψ₂ₖ((k+1)Δt)−ψ₂ₖ(kΔt)] (24)

substituting (24) in the conditions obtained in (14), the system remains maneuverable if

Σₖ₌₀^{K-1}[ψ₂ₖ((k+1)Δt)−ψ₂ₖ(kΔt)]+ψ(t₀)<ψ̅_{M} (25)

This means the solution of ψ₂ (t) can be recursively constructed from 0→tᵤ using (25), which is based on the analytic expressions obtained in (22) and (23). Conditions based on (8b) and (8d) are similarly derived.

The function of CSG-2 is designed based on the derived maneuverability conditions under saturated steering and steering rate constraints. Note that ψ_{CSG}, ψ̅_{CSG}, φ_{CSG}, φ̅_{CSG} are defined from CSG-1 implementation. CSG-2 can be summarized through (26),

$$\dot{ϕ} = \{ \begin{matrix}{\dot{ϕ}}_{ctrl} & if {ψ}_{s} ( {t}_{u 1} ) \leq {\overline{ψ}}_{CSG} , {ψ}_{2} ( {t}_{u 2} ) \geq {\underline{ψ}}_{CSG} \\ {\overline{\dot{ϕ}}}_{CSG} & if {ψ}_{2} ( {t}_{u 1} ) \leq {\underline{ψ}}_{CSG} \\ {\underline{\dot{ϕ}}}_{CSG} & if {ψ}_{2} ( {t}_{u 2} ) \geq {\overline{ψ}}_{CSG}\end{matrix} \qquad ( 26 )$$

Under the CSG-2 implementation depicted by the green trajectories in FIG. 5, it can be observed that the CSG-2 forces the system to implement maximum steering rate at an early enough time to ensure φ=φ_{CSG} before ψ=ψ̅_{CSG}. This guarantees that the system obeys maneuverability conditions at all times under a steering rate constraint. Upon implementation of CSG-2, the system successfully executes the turn without jackknifing. When programmed in MATLAB, CSG-2 takes a few milliseconds to construct ψ₂(t) in (9), check for maneuverability, and dictate whether the system needs to start steering to avoid jackknifing. This makes it practical for real-time system monitoring.

### IV. Controller Design

A. Bound Scheduling by Lookahead Control

Based on the results from Section III, a generalized method based on a lookahead control scheme over a finite preview horizon is developed for ensuring system maneuverability for a path tracking control scheme.

FIG. 6 describes the CSG logic flow used to impose steering and steering rate bounds from CSG-1 and CSG2 on an unconstrained path tracking controller based on information obtained in the lookahead horizon. This logic flow ensures maneuverability under constrained steering and steering rates. The horizon time length is determined by the worst case scenario, which requires the system to steer directly from one extreme to the other. This is calculated as T_{g}=|φ̅−φ|/\overline{\dot{φ}}. Once CSG-1 determines that the articulation angle violates the maneuverability conditions in the prediction horizon (sharp/unfeasible turns), it interferes by issuing a steering angle value that holds the maximum allowable articulation angle that prevents exiting the maneuverability range. Such a function (7) offers minimal interference as it only overwrites the steering angle when it is absolutely essential for maintaining maneuverability (safety). Sufficiency conditions generated by Proposition 2 are used to ensure that the system is capable of reaching the maneuverability conditions generated in the previous layer by CSG-1. Three states are defined for jackknife prevention (0: standby, 1: monitoring, 2: interference), and are assigned based on system behavior in the lookahead horizon. The standby state is activated if the predicted articulation trace does not enter the unmaneuverable range and control is guaranteed to be safe with respect to jackknifing. Monitoring state is entered when a jackknife risk (maneuverability range exit) is detected at a later control step in the horizon under the current controller implementation. CSG-1 and CSG-2 assess maneuverability after factoring in steering constraints from (7) and evaluating the terminal articulation angle ψ₂ (tᵤ) calculated from Proposition 2 at the time required for steering to reach φ̅_{CSG} or φ_{CSG}If the condition by (26) is met (i.e. maneuverability range), then CSG-2 remains in monitoring. Otherwise, the latest control time step is determined where it is required to start steering at the maximum steering rate in order to avoid jackknifing. Beyond such a point, no control action can save the system from jackknifing unless vehicle speed is reduced. At that control step, the state is switched to interference. In interference, the tracking controller's command is overwritten since system safety is jeopardized, and the tractor is commanded by CSG-2 to steer with the maximum rate (as seen in (26)) towards the values determined by CSG-1. Note that monitoring, used to judge the condition by (26), is still running in interference, but only to determine if safety can be regained at the next control step. Once it is determined that tracking of controller commands is safe again ((26) is satisfied), the CSG is set back to standby at the next control step and the path tracking controller regains control authority. Interference only occurs once the system has run into an unfeasible tracking problem based on the limitations imposed by the tractor-trailer geometry and the steering capabilities.

The developed CSG logic guarantees path tracking that is provably free from jackknifing regardless of the quality of the designed path and the control method.

B. Neural Network Controller

A neural network controller trained by a genetic algorithm was developed to control the tractor-trailer in this work, with inspiration coming from [16]. The genetic algorithm operations of crossover, mutation, and cloning were used where operations were performed on network weights (rather than a binary string genetic representation). The goal of the controller is path following rather than docking, so the structure and inputs differ from [16] even though the development concepts are similar. The controller consisted of a 3-layer 4-16-1 fully connected feedforward neural network with Rectified Linear Unit (ReLU) activation functions (ƒ (x)=max(0, x)) in the hidden layer and a simple linear activation function ƒ(x)=x on the output layer. The inputs to the network were the heading angle error at the lookahead tracking point ε_{θ}, the tractor-trailer articulation angle ψ, the heading angle error at the nearest point to the trailer axle center ε_{θ}_{ₙₚ}, and the distance error to the nearest point to the trailer axle center ε_{d}. The output of the network was the desired steering angle φ*.

The controller was trained for 146 generations with a population size of 1250. A heuristic H, shown in (27), was used to measure the performance of each controller. The goal of the heuristic was to provide higher values for controllers that had low distance error, low heading angle error, and lower steering effort. The constants α₁, α₂, and α₃ are manually adjusted to weigh the different heuristic objectives. The simulation was updated with period τₛ at each step k.

H[k]=H[k−1]+τₛ·(α₁·r_{d}+α₂·r_{ε}_{_{θnp}})+α₃·r_{φ} (27)

r_{d}=|v|/(|ε_{d}[k]|+1) (28a)

r_{ε}_{_{θnp}}=1/(|ε_{θnp}[k]|+1) (28b)

r_{φ}=τₛ/(|φ[k]−φ[k−1]|+τₛ) (28c)

Training was performed with the CSG placed after the controller to correct the control output so that the neural network could learn how to optimize performance with the CSG in the system.

### V. Simulation Results

A. Test Path Design

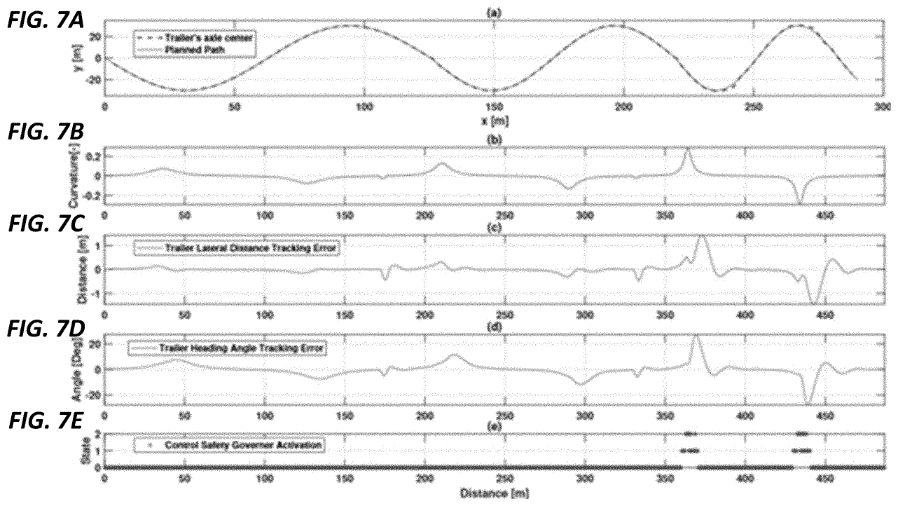

A tracking test path was designed to combine various situations and test both the bounded backward path tracking and the jackknife prevention provided by the CSG. The test path connects three sinusoidal waves of different frequencies with inherent discontinuities at the connection points. The curvature of the path is indicated by the solid blue line in FIG. 7A representing standard, sharp, and unfeasible curves as observed in the curvature graph of FIG. 7B. Curvature peaks of higher magnitude correspond to more challenging arcs since curvature is the inverse of the turning radius.

B. Control Performance Analysis

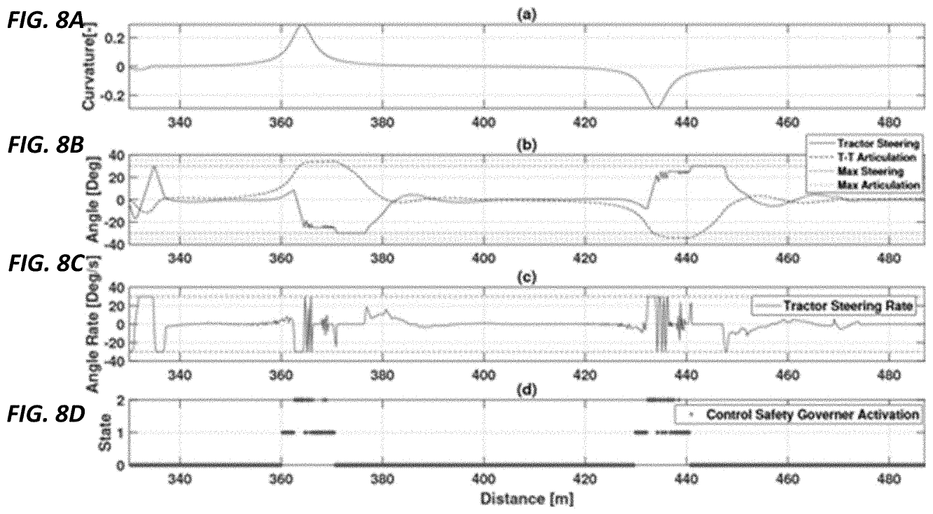

FIG. 7A shows the overall tracking result for the full test path. It can be seen that the neural network controller is able to handle the discontinuities between the sinusoidal function, stay on the path, and converge quickly to the path with minimum overshooting on the unfeasible tracking path. The distance and heading error are shown in FIG. 7. Besides the unfeasible path, the neural network controller handles the tracking objective extremely well without interference from the CSG system. The lateral distance error is almost negligible compared to the size of the trailer vehicle until the trailer encounters the unfeasible tracking curve. FIG. 8 shows a zoomed figure around the unfeasible path (the third sinusoid) where the CSG system is activated. The figure illustrates the tractor steering and steering rate, the articulation angle, and the change of states for the CSG. At the beginning of FIG. 8C, it is clear that the controller is applying the maximum steering rate to handle the discontinuity without the help of the CSG. Then, when the vehicle is approaching the unfeasible turn, the CSG starts to observe the risk of jackknifing and changes its state from standby to monitoring. Once the risk is confirmed, the CSG changes its state from monitoring to interference and starts to apply and maintain the maximum allowable steering rate. From the graphs of the steering angle and rate in FIG. 8B it can be observed that the lookahead control system is able to foresee the jackknife risk induced by the upcoming sharp curve and pro-actively assign maximum steering effort before encountering the unfeasible turn. After the risk of jackknifing has passed and the steering has been corrected, the CSG returns to standby mode.

### VI. Conclusion

As described in Example 1, system maneuverability conditions were derived for backward driving tractor-trailers to provide provable assurance against jackknifing. The CSG was designed to ensure maneuverability under steering angle and rate constraints and used in a lookahead control system policy to achieve safe path tracking. A neural network controller was designed with the CSG in the loop to optimize path tracking performance with the existence of bounds imposed by the CSG. Simulation results indicate the success of the neural network controller in tracking paths with discontinuities and unfeasible turns, as well as the success of the CSG-based lookahead control policy in jackknifing prevention.

### Example 2

Tractor-trailer path tracking in backward motion is a challenging nonlinear control problem in automated vehicle development. The control challenges arise from the fact that a backward driving articulated vehicle is an underactuated system with unstable internal dynamics and coupled nonlinear terms. Additionally, there exists a relative body angle margin for saturated steering input beyond which a jackknife accident is unavoidable if backing further. In this work, three different controllers were designed for tractor-trailer reverse motion: a proportional integral controller, a sliding mode controller, and a neural network controller. A generic control safety governor was developed to supervise the tracking control algorithms, which overrides control when necessary to ensure jackknife-free operation. The controllers' path tracking performance was tested on an increasingly rigorous path with introduced discontinuities, and a comparative study of the three controllers was conducted. The performance differences and characteristics of each control algorithm are analyzed for the studied scenario.

### I. Introduction

Backing a vehicle hitched with a trailer is a challenging skill for human drivers. The learning curve is steep, and a complete parking or docking process can take rounds of maneuvers. To reduce driver work load and to improve time efficiency, low-speed steering control of tractor-trailer vehicles can be automated in current driver assistance system and autonomous vehicle developments. Still, various challenges exist in such control problem.

The tractor-trailer system is highly non-linear and has physical bounds on both the articulation state and the steering input. The trailer kinematics are naturally asymptotically stable in tractor forward direction path tracking under nonsliding conditions [1], [2], but is internally unstable, underactuated, and prone to jackknifing in the backward driving direction driving [1], [3]. Further, the articulated vehicle can become unmaneuverable beyond a certain range of articulation angles depending on the vehicle's geometry [4].

Existing literature proposes a multitude of control methods for the general topic of tractor-trailer path tracking control. Path tracking in forward motion can be directly achieved by a wide range of control methods since the system is internally stable. Methods include LQR [3], feedback linearization [5], back-stepping [6], Linear MPC [3], etc. For backward path tracking, control methods have to be redesigned since the vehicle system becomes internally unstable. Geometrical coordinate transformation methods are developed in [1] [7] to transform the tracking target from the trailer body onto the tractor steering, so that simple control algorithms like PI control can be applied. A virtual forward driving tractor is used in [2], [8], [9] to transform the controlled subject from an unstable system to a stable system so that control methods for forward driving such as feedback linearization [8] [2] can be applied. To directly solve the nonlinear backing control problem, various methods have been derived including neural network controllers [10], [11], nonlinear feedback stabilization [12], [13], fuzzy control [14], [15], and explicit MPC using multi-parametric programming under affine approximation [16], [17]. Applicable control methods are further divided based on hitch location, as tractor-trailer vehicles with on-axle hitches are deferentially flat, but those with off-axle hitches are deferentially non-flat [18], [19].

This example focuses on investigating and comparing path tracking control methods for an off-axle hitched tractor-trailer vehicle in reverse motion. Three control methods representing basic, classical, and modern control techniques are selected and developed to study their effectiveness and complexity in the defined control problem. The example starts by analyzing the tractor-trailer internal stability and deriving an explicit maneuverable state margin in Section II, which leads to a Control Safety Governor (CSG) designed to prevent jackknifing for all controllers when given an unsafe tracking path. The three controller designs are explained in Section III. Inspired by the sliding mode controller for a single vehicle's path tracking in [20], [21] and the coordinate transformation technique in [7], a Sliding

Mode (SM) controller is developed for tractor-trailer backward path tracking, in comparison with the simple PI controller strictly relying on the coordinate transformation from [1], [7]. For the case of directly handling the tractor-trailer's geometry without simplification, a Neural Network (NN) path tracking controller is designed. The three controller cases are fine tuned by an optimization method for comparison fairness. In Section IV, they are tested using a common platform to study the performance and computation cost difference both qualitatively and quantitatively.

### II. System Model

A. Control System Model

The tractor-trailer control oriented model used in this paper is developed as a double bicycle model based upon the models from [7], [22]. The tractor vehicle is modeled after a light duty truck with the hitch located behind the rear bumper and connected to a single axle trailer. The tractor-trailer vehicle model parameters related to path tracking control are denoted in FIG. 1A. Parameters θ₁ and θ₂ refer to the tractor's and the trailer's heading angle respectively defined by the Earth coordinate frame, and the difference is denoted as the articulation angle ψ=θ₂−θ₁. The tractor's front wheel steering angle φ, which is the control variable in this problem, is bounded by φ∈[φ, φ̅]. Counterclockwise direction is denoted as positive for all angular state variables in this work. The steering kinematics of a tractor-trailer vehicle for a control oriented model in low speed are defined by four parameters: The tractor vehicle's wheelbase L₁ measured from the tractor front axle to rear axle, the trailer vehicle's wheelbase L₂ measured from the hitch to the trailer's axle, the hitch length l measured from the tractor rear axle to the hitch, and the tractor's longitudinal speed v, with negative values for backward driving. Using (x₁, y₁) as the tractor's rear axle center location in the Earth coordinate frame, the control system model is summarized as in (29a-29e). Note that the sgn operator is used to switch the model between forward driving and backward driving.

$$\begin{matrix}\dot{x} = v cos {ϕcosθ}_{1} & ( 29 a ) \\ \dot{y} = v cos {ϕsinθ}_{1} & ( 29 b ) \\ \dot{{θ}_{1}} = \frac{v tan ϕ}{{L}_{1}} & ( 29 c ) \\ \dot{ψ} = - \frac{v tan ϕ}{{L}_{1}} - v \frac{v ( {L}_{1} sin ψ + sgn ( v ) l tan ϕcosψ )}{{L}_{1} {L}_{2}} & ( 29 d ) \\ \dot{{θ}_{2}} = \dot{{θ}_{1}} + \dot{ψ} & ( 29 e )\end{matrix}$$

Because the studied control system has only one degree of freedom in control (the tractor's steering), tracking control is designed to minimize only the trailer's tracking error. Therefore, control reference variables are defined by the trailer's axle center using distance and direction errors. Denoting P_{NP} as the nearest point from the trailer axle center P₂ to the tracked path, the distance in between is the lateral distance tracking error ε_{d}, with the right-hand side of driving direction defined as positive error. The angular difference between the trailer's heading angle and the tangent line at P_{NP} is defined as the actual heading angle tracking error, calculated as ε_{θ}_{ₙₚ}=θ_{PNP}−θ₂. To foresee upcoming turns in the path, a reference point P_{R} is defined with a lookahead distance L_{A} along the path ahead of P_{NP}. The angular difference between the trailer's heading angle and the tangent line at P_{R} is defined as the reference heading angle tracking error, calculated as ε_{θ}=θ_{PR}−θ₂. For discrete waypoints from the path planner, quadratic line functions are fitted onto the waypoints by Linear Least Square method with a moving horizon, which convert the tracking calculations into continuous domain for smooth error dynamics.

B. System Analysis

To identify system properties and conditions for controller development, the internal stability is studied and maneuverability is defined. Let ƒ(ψ, θ₂) be a two-dimensional function concatenating (29e) and (29d) (i.e. ƒ(ψ, θ₂)=[\dot{θ}₂, \dot{ψ}]^{T}).

1) System Equilibrium Points:

Under a constant backwards velocity and heading angle in θ₂∈[0,2π), articulation angle in ψ∈[0,2π), and front wheel steering angle in range φ∈[(φ, φ̅], the system has an equilibrium set ε={(ψ,θ₂)|ψ=(0 or π), φ=0, θ₂∈[0,2π))}. This indicates that in backwards driving, the system is at equilibrium when the tractor and trailer are aligned in either direction with no steering input applied to the system.

2) System Internal Stability:

System stability is investigated under zero control input. The system backwards driving dynamics become

$$\dot{ψ} = {\dot{θ}}_{2} = - \frac{v}{{L}_{2}}$$

sin ψ, with v being negative for backward driving, It can be shown that:

(a) The ω-limit set for trajectories starting at ψ=0, θ₂∈[0,2π) is Ω₁={(ψ, θ₂)|ψ=0, η₂∈[0,2π))}.

(b) The ω-limit set for all other trajectories is Ω₂={(ψ, η₂)|ψ=π, θ₂∈[0,2π))}.

This indicates that equilibrium points within the set {ψ=0, θ₂∈[0,2π)} are unstable, whereas the ones in the set {ψ=π, θ₂∈[0,2π)} are stable. However, the latter set of equilibrium points corresponds to the case where the tractor and trailer overlap, which is physically unfeasible.

3) Derivation of maneuverability conditions under saturated inputs: Maneuverability for tractor-trailer systems is defined as having the ability of both increasing and decreasing the articulation angle ψ using values within the limited steering angle range [φ, φ̅]. The bounds on maneuverable articulation angle ψ and ψ are explicitly derived below.

### Definition

The system is said to be maneuverable within a maneuverability range (ψ_{M}, ψ̅_̅{̅M̅}̅) if ∀ψ∈(ψ_{M}, ψ̅_̅{̅M̅}̅), ∃φ₁, φ₂∈[φ, φ̅]|\dot{ψ}(φ₁)>0, \dot{ψ}(φ₂)<0.

Proposition 1:

For a tractor-trailer system with an off-axle hitch, the system remains maneuverable as long as the articulation angle remains within the range (ψ_{M}, ψ̅_̅{̅M̅}̅), where

$$\begin{matrix}\underline{{ψ}_{M}} = arctan 2 ( {L}_{1} , - l tan \overline{ϕ} ) - {cos}^{- 1} ( - \frac{tan \overline{ϕ}}{[ {( l \text{/} {L}_{2} tan \overline{ϕ} )}^{2} + {( - {L}_{1} \text{/} {L}_{2} )}^{2} ]} ) & ( 30 ) \\ \overline{{ψ}_{M}} = arctan 2 ( {L}_{1} , - l tan \underline{ϕ} ) - {cos}^{- 1} ( - \frac{tan \underline{ϕ}}{[ {( l \text{/} {L}_{2} tan \underline{ϕ} )}^{2} + {( - {L}_{1} \text{/} {L}_{2} )}^{2} ]} ) \\ Proof \text{:} \\ Setting u ( ϕ ) := ( \frac{v}{{L}_{1} } ) tan ϕ & ( 31 ) \\ \dot{ψ} = u ( ϕ ) ( \frac{l}{{L}_{2}} cos ( ψ ) - 1 ) - \frac{v sin ψ}{{L}_{2}} & ( 32 )\end{matrix}$$

ψ_{M} is the first value for ψ<0 for which the system is no longer maneuverable under minimal saturated steering input where ψ_{M}: {max(ψ)∀ψ<0|φ∈[(φ, φ̅)], \dot{ψ}≤0}, and max (ƒ(ψ_{M},φ))=0, where ƒ(ψ, φ) is a function representing the body angle rate defined by the right hand sides of (29d) and (29e).

Assuming that l<L₂, which is the case for tractor-trailers in practice, it is clear that for a ψ:|ψ|<π/2, \dot{ψ} is a decreasing function of u(φ).

So, max ƒ (ψ_{M},φ)=ƒ (ψ_{M}, u⁻¹(min u(φ)))=0.

For φ:

$$\vert ϕ \vert < \frac{π}{2} ,$$

u(φ) is a decreasing function of φ. This implies that min(u(φ))=u(φ̅). So, ƒ(ψ_{M}, φ̅)=0. Using (29b), and rearranging some terms,

$$- v sin \frac{( {\underline{ψ}}_{M} )}{{L}_{2}} + u ( \overline{ϕ} ) l cos ( {\underline{ψ}}_{M} ) \text{/} {L}_{2} = u ( \overline{ϕ} ) \qquad ( 33 )$$

Constructing a right-angle triangle with an angle α and a hypotenuse M such that tan α:=(−v/L₂)/(u(φ̅)(l/L₂)) and M:=((−v/L₂)\hat{ }2+(u(φ̅)(l/L₂)\hat{ }2)^{-1/2}, it becomes clear that

$$- ( \frac{v}{{L}_{2}} ) = M sin α and u ( \overline{ϕ} ) ( \frac{l}{{L}_{2}} ) = M cos α .$$

Substituting in (33) and using trigonometric identities,

$$\begin{matrix}M sin α sin {\underline{ ψ}}_{M} + M cos α cos {\underline{ ψ}}_{M} = u ( \overline{ϕ} ) & ( 34 a ) \\ cos ( α - {\underline{ ψ}}_{M} ) = u ( \overline{ϕ} ) \text{/} M & ( 34 b ) \\ {\underline{ψ}}_{M} = α - {cos}^{- 1} ( \frac{u ( \overline{ϕ} )}{M} ) & ( 34 c )\end{matrix}$$

Substituting the values of M and a in the previous equations, the expression in (30) is obtained. (31) is similarly derived.

As long as the relative body angle between the tractor and the trailer remains bounded within ψ_{M} and ψ̅_{M}, it is possible to maneuver the trailer in any desired direction while backing. Once ψ exceeds that range, ψ will approach π regardless of the tractor steering effort, leading to eventual jackknifing. The only way that the system can recover from such a condition is to change to forward driving and bring ψ to a value within the maneuverable range, then switch again to backwards driving. In order to enforce system maneuverability, a safety governor is developed to ensure that the system remains within [ψ_{M}, ψ̅_{M}] for any implemented controller.

### III. Control Methods

A. Control Safety Governor

Using the derived maneuverability condition on the articulation range, a Control Safety Governor (CSG) is developed to inspect the steering control command from a path tracking controller for potential control failure incidents and overwrite the steering command when necessary. The proposed CSG serves independently from the planner and thus provides additional safety, foregoing reliance on jackknife prevention in the path planning stage as in [23]. Control failure situations for a tractor-trailer reverse tracking scenario are defined when either the body articulation angle enters into the unmaneuverable range or a jackknife collision occurs, whichever range is more restrictive. The articulation angles at which jackknife collision occurs can be determined geometrically, denoted as ψ_{JK} and ψ̅_{JK}. To avoid jackknife, the steering command from the active controller is first tested by the CSG using 1-step prediction before passing the control command to the steering actuator. The logic is shown in FIG. 9. When it is projected that the application of the current-step control will bring the tractor-trailer articulation angle into the failure region [symbol] ={ψ_{F}|ψ∉[ψ_{M}, ψ̅_{M}]|ψ_{F}∉[ψ_{JK}, ψ̅_{JK}]}, the steering control is switched from the objective of tracking to the objective of maintaining the current-step articulation angle ψ(k) from increasing until the tracking command no longer jeopardizes the control safety. Index k refers to the discrete control steps:

$${ϕ}_{M} ( k ) = {tan}^{- 1} ( - \frac{{L}_{1} sin ( ψ ( k ) )}{{L}_{2} + sgn ( v ) l cos ( ψ ( k ) )} ) \qquad ( 35 )$$

Because there can be a jump from the current steering angle to φ_{M}(k), which is impractical to execute, the CSG adopts a soft margin Δψ_{S} and a hard margin Δψ_{S} away from ψ_{F} to gradually switch the steering objective into stopping body articulation angle increase. Using the predicted next-step steering command \hat{ψ}(k+1) from the path tracking controller, the damping gain K of switching and the damped current-step steering command Φ_{D} (k) are determined as:

$$\begin{matrix}K = min [ max [ \frac{\vert \hat{ψ} ( k + 1 ) \vert - ( {ψ}_{F} - Δ {ψ}_{S} )}{Δ {ψ}_{S} - Δ {ψ}_{H}} , - 1 ] , 1 ] & ( 36 ) \\ {ϕ}_{D} ( k ) = K ( {ϕ}_{M} ( k ) - ϕ ( k ) ) + ϕ ( k ) & ( 37 )\end{matrix}$$

It can be seen that no CSG interference on the tracking controller's steering command is applied when |\hat{ψ}(k+1)≤ψ_{F}−Δψ_{S}. When |\hat{ψ}(k+1)|≥ψ_{F}−Δψ_{H}, steering override is fully applied for body articulation angle maintenance. A more rigorous version of the CSG system is shown in [4], which further ensures jackknife-free tractor-trailer path tracking with a strictly bounded steering rate.

B. A PI Controller

A path tracking PI controller was developed by simplifying the control law in [7] and using the proposed coordinate transformation. The controller uses two error states: 1) the heading angle error ε_{ϑ} at the reference point, which is the proportional part, and 2) the lateral tracking distance offset ε_{d}, which is regarded the integral part (the lateral offset accumulates from heading angle error). The core control law of PI is given through a virtually defined control variable of trailer path curvature demand κ_{d}, which directly acts on the controlled state and maintains the control simplicity:

κ_{d}=κ_{ξ}ε_{d}+k_{θ}ε_{θ} (38)

The technique of coordinate transformation from [7] transforms the virtually defined control variable through the geometry of the tractor-trailer into the actual control command, which is the tractor vehicle's front wheel steering angle φ_{d}. System nonlinearity is absorbed by the coordinate transformation and not directly handled by the PI controller. The transformation is achieved using the calculation of trailer path curvature κ₂ for a given set of body articulation angle ψ and tractor front wheel steering angle φ [7]:

$${κ}_{2} = - \frac{sin ψ + l {F}_{k} ( ϕ ) cos ψ}{{L}_{2} [ cos ψ - l {F}_{k} ( ϕ ) sin ψ ]} \qquad ( 39 )$$

where Fₖ refers to the tractor's steering map function, describing the relationship from the tractor's steering angle φ to the tractor's rear axle center path curvature κ₁. The function can either be derived mathematically using model geometry or by directly fitting a polynomial function to the sampled input-output data as suggested in [7]. The latter method is practically more convenient in actual implementation when system parameter uncertainty exists, and is adopted in this study. By taking the inverse of steering map function Fₖ, the tractor steering angle control command φ_{d} can be calculated from the trailer's path curvature command κ_{d}:

$${ϕ}_{d} = {F}_{κ}^{- 1} ( \frac{{κ}_{d} {L}_{2} cos ψ + sin ψ}{{κ}_{d} l {L}_{2} cos ψ - l cos ψ} ) \qquad ( 40 )$$

C. Sliding Mode Controller

To develop a sliding mode tracking controller, it is critical to select the sliding surface such that tracking errors in position and orientation converge to zero in finite time due to the non-holonomic motion constraints in this problem. The sliding surface is selected as:

s(t)=\dot{ε}_{d}+k₁ε_{d} (41)

where k₁>0∈ [symbol] and the lateral error is given by:

ε_{d}=sin(θ_{d})(x₂−x_{d})+cos(θ_{d})(y₂−y_{d}) (42)

where x₂ and y₂ are the coordinate of P₂ shown in FIG. 1. x_{d}, y_{d}, and θ_{d} are the targeted position and orientation given by a planner. The time derivative of s(t) is given by:

\dot{s}(t)=\ddot{ε}_{d}+k₁\ddot{ε}_{d} (43)

Following Gao's reaching law method [24], a practical general form of the reaching law is:

\dot{s}(t)=−Q sgn(s) (44)

where Q∈R_{>0}. The desired steering input is given by merging the kinematics equation (29) into (43) and (44):

$${ϕ}_{d}^{SMC} = {tan}^{- 1} ( - \frac{tan ψ}{l} + \frac{{k}_{1} {L}_{2} sin ( {ɛ}_{θ} )}{v l cos ψ sin {ɛ}_{θ}} + {L}_{2} Q \frac{sgn ( s )}{{v}^{2} l cos ( ψ ) cos {ɛ}_{θ}} ) \qquad ( 45 )$$

Note that the resulting steering input command has a heading angle error term and thus couples the lateral distance and the heading angle errors. In addition, the possible singularity when

$$\vert ψ \vert = \frac{π}{2}$$

is prevented by the CSG and the goal is to follow the feasible path such that

$$\vert {ɛ}_{θ} \vert < \frac{π}{2} .$$

For the stability assurance of the proposed controller, let V(t)=½s² (t) be a Lyapunov function candidate.

Differentiating V (t) and substituting (15) yields:

\dot{V}(t)=s(t)\dot{s}(t)=s(t)(\ddot{ε}_{d}+k₁\ddot{ε}_{d})=−s(t)(Q sgn(s)) (46)

Under the condition Q>0, V (t) is negative semi-definite and s(t)=0 will be reached in a finite time.

The speed terms in the denominator may cause undesirable steering input for the controller implementation and this particular application of low-speed path tracking. For this reason, the gain factors Q and k₁ are designed as:

$$Q = \frac{\hat{Q} {v}^{2} l cos ψ}{{L}_{2}} , {k}_{1} = \frac{{\hat{k}}_{1} l v cos ψ}{{L}_{2}} \qquad ( 47 )$$

Thus, the steering input can be written as:

$${ϕ}_{d}^{SMC} = {tan}^{- 1} ( - \frac{tan ψ}{l} + {\hat{k}}_{1} tan ( {ɛ}_{θ} ) + \hat{Q} {tan}^{- 1} ( s ( t ) ) ) \qquad ( 48 )$$

D. Neural Network Controller

The neural network controller used for comparison was developed by the authors of this work previously in [4]. Since neural networks are essentially universal function approximators [25], they can output a control signal given inputs chosen to represent the vehicle state, despite the nonlinear nature of the tractor-trailer problem. The network was trained using neuroevolution [26], comprised of a Genetic Algorithm (GA) modifying the weights of a fixed neural network through repeated simulation. In similar nature to [11], a fixed structure feed-forward neural network with a single hidden layer is chosen. The fully connected network consists of an input layer containing 4 neurons (ψ, ε_{θ}_{ₙₚ}, ε_{d}, and ε_{θ}), a hidden layer experimentally determined with 16 neurons, and a single-neuron output layer of φ_{d}. Each neuron output yᵢ in the hidden layer is given by:

yⱼ=ƒ(Σᵢwᵢⱼxᵢ)ƒ(x)=max(0,x) (49)

where i is the index of the input, wᵢⱼ is the weight for input i going to neuron j, and ƒ(⋅) is the non-linear activation function. A bias term is not included as it did not effect performance in this problem. ReLU (Rectified Linear Unit) was chosen over sigmoid and tan h activation functions for its advantage in being simple and fast in computation.

The network is trained using neuroevolution rather than back-propagation because training data is not available in this scenario since the desired steering angle given the tractor-trailer system state is not known. Using GA optimization to adjust network weights corresponding to chromosomes, cloning, crossover, and mutation operations are applied to the best individuals in preceding populations to create future generations. The heuristic function assigns high value to the controller candidates that have low lateral tracking distance error and low heading angle error. To ensure smooth tractor steering, a heuristic term rewarding smaller step change in steering angle is included. The heuristic is shown below:

H[k]=H[k−1]+Σₛ·(α₁r_{d}+α₂r_{ε}_{_{θnp}})+α₃r₁, (50)

r_{d}=|v|/(|ε_{d}[k]|+1) (51a)

r_{ε}_{_{θnp}}=1/(|ε_{θnp}[k]|+1) (51b)

r_{φ}=τₛ/(|φ[k]−φ[k−1]|+τₛ) (51c)

The heuristic value at each simulation update step k is denoted by H[k], and is computed by adding an update term to H[k−1], with tunable weights assigned to the aforementioned three objectives. The update term includes the simulation update period τₛ so that controllers trained under simulations with different update rates can be compared. The final network evolved to convergence in 150 generations with a population size of 750. The network parameters are fixed after training, allowing light online control computation.

### IV. Results and Discussion

A. Test Path and Test Conditions

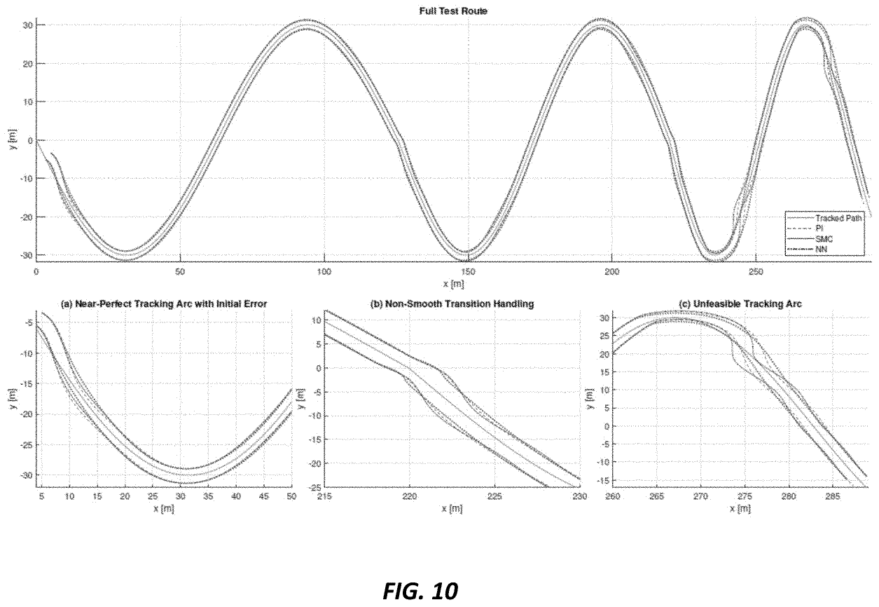

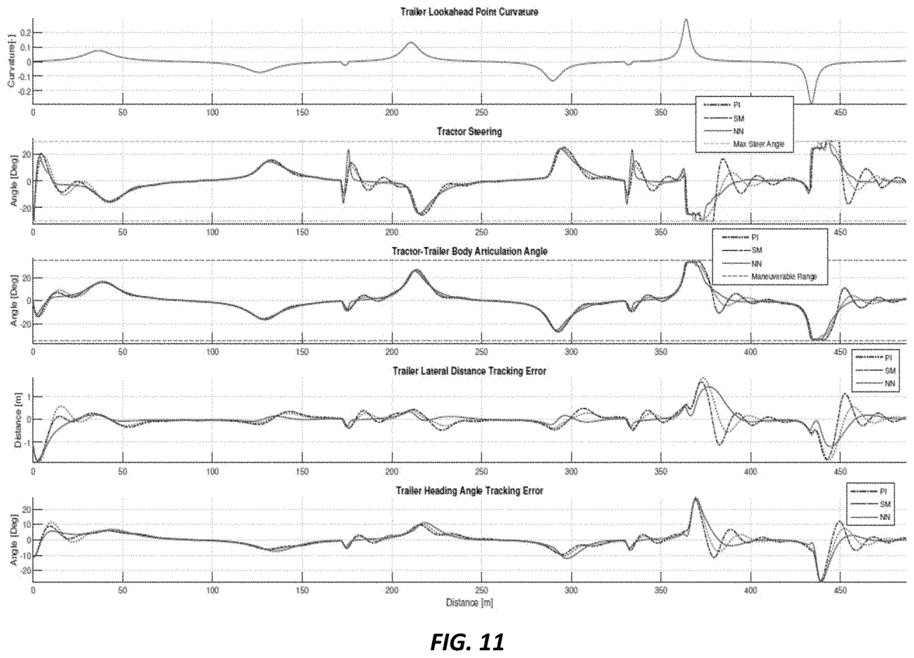

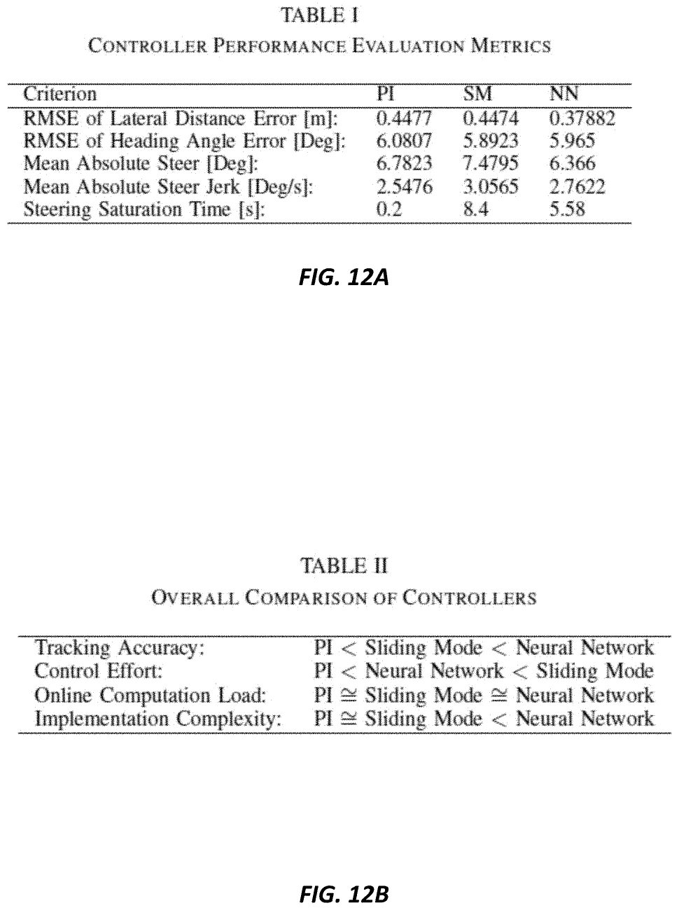

A tracking test path was designed to combine various scenarios to rigorously test the performance of the three controllers. The test path connects three sinusoidal waves of different frequencies, visualized by the solid magenta line in FIG. 10. The three waves represent normal, sharp, and unfeasible curves as indicated by the curvature graph in FIG. 11. Sinusoidal waves can be used to test a full range of turning radii in the continuous domain, which is also the selection in [16], [17]. The connection point between two sinusoidal waves of different frequencies creates a nonsmooth transition that can test the controller's transient response. Note that the third sinusoidal path's curvature peaks are designed to exceed the minimum effective turning radius of the tested tractor-trailer vehicle, so there is no controller that can possibly track the path without either jackknifing or overshooting. This path section is to verify the effectiveness of the CSG for jackknife prevention on unfeasible curves. By relaxing the control command from solely the tracking accuracy objective, the CSG allows the tractor-trailer to safely drive through an unfeasible curve.

Using the same tractor-trailer model, test path, tracking input structure, and initial conditions, the three developed path tracking controllers are compared against each other. To eliminate human bias in controller gain tuning, specifically for the PI and SM controller cases, the controllers are all machined tuned by GA optimization with the same performance rewarding heuristic as the NN in (50). Though reaching the global optima is not guaranteed by a single run of GA optimization, the process was repeated with multiple GA trails under different initial conditions until a repetitive superior result was observed. Considering the number of possible local optima is limited, it is safe to conclude that the controller tuning has been fully optimized under the same standard by extensive offline training and that the comparison study is conducted under fair conditions. The tracked path and the trailer vehicle's wheel traces under the three controllers are visualized in FIG. 10, and the control inputs, states, and errors of the three cases are compared in FIG. 11. Considering the difference in trailer wheel distance profiles caused by different tracking error distributions of the three controllers, the profiles in FIG. 11 are aligned by the projected distance along the tracked path.

B. Performance Comparisons and Analysis

Although the tractor-trailer vehicle begins with an initial position and heading offset, all three controllers steer the vehicle to quick convergence onto the tracked path before the first corner. The PI and the SM controllers have smooth steering with more distance and angle tracking error overshoot than the NN controller. The SM controller is superior to the PI controller in regards to having less overshoot and faster convergence. The NN controller is further advantageous in reducing tracking error without overshoot, though it requires faster steering change. All three controllers handle the first sinusoidal path of moderate curvature with minimal tracking error. When encountering non-smooth transitions, the NN controller fully absorbs the disturbances without error overshoot but at the cost of aggressive steering maneuvers. Tracking performance differences are larger at the second sinusoidal path of more challenging curvature, showing the SM being the most precise in heading angle tracking, while the NN being far superior in lateral distance error. Note that the SM controller does not exhibit control chattering thanks to the reaching law's design methodology. When driving along the third sinusoidal path with unfeasible curvatures for the tractor-trailer, all three controllers pass through with well-mannered error behavior and without jackknifing. Safe passing is the result of the CSG's external interference, as there is no state bound that can be internally applied on any of the three control algorithms. This is indicated by the extended articulation angle saturation at the maneuverable bounds during the two extreme corners. The NN controller is especially advantageous in such situations, as shown by the obvious tracking advantage in both distance and angle. This is the result of the NN's adaptive and complicated structure, allowing it to learn control with the existence of the CSG system through offline training. It should be noted that the PI controller performance does not lag far behind the other two more advanced ones, because the problem complexity for PI has been significantly reduced by employing the coordinate transformation using the tractor-trailer kinematics. The effective control problem directly handled by the PI controller is therefore of simple linear error dynamics.

Metrics of tracking errors and control efforts are generated for each controller in Table I to quantify the differences. With a more sophisticated control law, the SM controller achieves a small advantage over the PI controller in tracking performance of both lateral distance and heading angle. The NN controller attains significantly higher tracking quality in lateral distance error, while falling slightly behind the SM in heading angle error. Note that the NN controller's performance can be further balanced by tuning heuristic parameters based on needs. Superiority in tracking quality generally comes at the cost of more control effort, as in the comparisons of SM vs. PI and NN vs. PI. Comparing the NN and the SM controllers, however, superior tracking performance is attained with reduced control effort. This is because of the NN's larger number of adjustable parameters and extensive offline training; a quasi-optimal control law is generated from reinforcement learning by evolving neural network weights. Such a control method has been known in the field as Approximate Dynamic Programming or NeuroDynamic Programming [27] [28], and is regarded as a type of direct adaptive optimal control [29]. Because the studied model motion is bounded by the nonholonomic constraints, which are defined by the kinematic parameters of wheelbases and hitch length, the control system is fully time-invariant. Thus, the determination of optimal control law can be fully transferred offline to formulate a static approximate optimal control map. By externally defining the performance criterion to be optimized and searching offline through simulation based optimization, the optimal control law can be approximated without mathematically solving the control problem online. Although there is no guarantee of boundedness on the controller, the developed outer layer of the CSG system ensures no jackknife accidents can occur. This effectively applies state constraints on the articulation angle with the existence of the control constraints of steering angle range.

The qualitative comparisons of the three controllers are further summarized in Table II, where the NN controller excels in tracking accuracy performance with a relatively low control effort. Because none of the three controllers require iterative calculations online, the controllers are regarded with equal online computational complexity and are all very light. Though the NN's online usage only requires a number of multiplications and numerical comparisons, the NN generation comes at the cost of intensive offline training computation. The amount of computation memory and time grows with the number of layers and nodes defined in the network, and the necessary layer and node counts are not trivial to determine. As a result, the trial-and-error process further increases the development time. Additionally, the training needs to be redone each time the tractor vehicle is combined with a different hitch or trailer, as the trained NN is specific to the model parameters. In comparison, the PI and the SM controllers only require a model parameter update to operate successfully. Due to the above reasons, the NN controller is rated with higher implementation complexity than the other two control methods.

### V. Conclusion

As described in Example 2, three tractor-trailer backward path tracking controllers were developed and compared for tractor-trailer systems with off-axle hitching, including a PI, a sliding mode, and a neural network controller. On the outer layer, a generic Control Safety Governor was designed to ensure jackknife-free operation of all the controllers. While all three controllers showed good tracking accuracy, the comparative analysis indicated the superior performance of the neural network controller, though with the price of heavy offline training and a more complex structure.

### REFERENCES

### Example 1

[1] C. Pradalier and K. Usher, “Robust trajectory tracking for a reversing tractor trailer,” Journal of Field Robotics, vol. 25, no. 6-7, pp. 378-399, 2008.
[2] Z. Leng and M. A. Minor, “A simple tractor-trailer backing control law for path following with side-slope compensation,” in Robotics and Automation (ICRA), 2011 IEEE International Conference on, pp. 2386-2391, IEEE, 2011.
[3] A. K. Khalaji and S. A. A. Moosavian, “Robust adaptive controller for a tractor-trailer mobile robot,” IEEE/ASME Transactions on Mechatronics, vol. 19, no. 3, pp. 943-953, 2014.
[4] A. Astolfi, P. Bolzern, and A. Locatelli, “Path-tracking of a tractor-trailer vehicle along rectilinear and circular paths: a lyapunov-based approach,” IEEE transactions on robotics and automation, vol. 20, no. 1, pp. 154-160, 2004.
[5] A. Gonzalez-Cantos and A. Ollero, “Backing-up maneuvers of au-” tonomous tractor-trailer vehicles using the qualitative theory of nonlinear dynamical systems,” The International Journal of Robotics Research, vol. 28, no. 1, pp. 49-65, 2009.
[6] J. NILSSON and S. ABRAHAM, “Trailer parking assist (tpa),” 2013.
[7] J. Cheng, Y. Zhang, and Z. Wang, “Backward tracking control of mobile robot with one trailer via fuzzy line-of-sight method,” in 6th Int. Conf. on Fuzzy Systems and Knowledge Discovery, 2009, vol. 4, pp. 66-70, IEEE, 2009.
[8] J. Cheng, B. Wang, and Y. Xu, “Backward path tracking control for mobile robot with three trailers,” in International Conference on Neural Information Processing, pp. 32-41, Springer, 2017.
[9] J. Yuan, F. Sun, and Y. Huang, “Trajectory generation and tracking control for double-steering tractor-trailer mobile robots with on-axle hitching,” IEEE Transactions on Industrial Electronics, vol. 62, no. 12, pp. 7665-7677, 2015.
[10] J. Morales, J. L. Mart'inez, A. Mandow, and A. J. Garc'ia-Cerezo, “Steering the last trailer as a virtual tractor for reversing vehicles with passive on-and off-axle hitches,” IEEE Transactions on Industrial Electronics, vol. 60, no. 12, pp. 5729-5736, 2013.
[11] J. Cheng, Y. Zhang, S. Hou, and B. Song, “Stabilization control of a backward tractor-trailer mobile robot,” in Intelligent Control and Automation (WCICA), 2010 8th World Congress on, pp. 2136-2141, IEEE, 2010.
[12] J. Backman, T. Oksanen, and A. Visala, “Navigation system for agricultural machines: Nonlinear model predictive path tracking,” Computers and Electronics in Agriculture, vol. 82, pp. 32-43, 2012.
[13] Y. Bin and T. Shim, “Constrained model predictive control for backing-up tractor-trailer system,” in Intelligent Control and Automation (WCICA), 2012 10th World Congress on, pp. 2165-2170, IEEE, 2012.
[14] B. Yang, S. Taehyun, and F. Nenglian, “Look-ahead path information based receding horizon control for backing-up tractor-trailer systems,” in 31st Chinese Control Conference, pp. 4201-4206, IEEE, 2012.
[15] J. R. Koza, “A genetic approach to the truck backer upper problem and the inter-twined spiral problem,” in Neural Networks, 1992. IJCNN., International Joint Conference on, vol. 4, pp. 310-318, IEEE, 1992.
[16] M. Schoenauer and E. Ronald, “Neuro-genetic truck backer-upper controller,” in Proceedings of the First IEEE Conference on Evolutionary Computation. IEEE World Congress on Computational Intelligence, pp. 720-723 vol. 2, June 1994.
[17] Z. Leng and M. Minor, “A simple tractor-trailer backing control law for path following,” in Intelligent Robots and Systems (IROS), 2010 IEEE/RSJ International Conference on, pp. 5538-5542, IEEE, 2010.
[18] U. Ozuner, T. Acarman, and K. A. Redmill, . . . Autonomous ground vehicles. Artech House, 2011.

### Example 2

[1] C. Pradalier and K. Usher, “Robust trajectory tracking for a reversing tractor trailer,” Journal of Field Robotics, vol. 25, no. 6-7, pp. 378-399, 2008.
[2] J. Cheng, Y. Zhang, S. Hou, and B. Song, “Stabilization control of a backward tractor-trailer mobile robot,” in Intelligent Control and Automation (WCICA), 2010 8th World Congress on, pp. 2136-2141, IEEE, 2010.
[3] M. Yue, X. Hou, and L. Yang, “An efficient trajectory tracking control for tractor-trailer vehicle system,” in Control Conference (CCC), 2017 36th Chinese, pp. 546-551, IEEE, 2017.
[4] M. Hejase, J. Jing, J. M. Maroli, Y. B. Salamah, L. Fiorentini, and U. Ozguner, “Constrained backward path tracking control using a . . . plug-in jackknife prevention system for autonomous tractor-trailers,” in 2018 21st International Conference on Intelligent Transportation Systems (ITSC), pp. 2012-2017, IEEE, 2018.
[5] A. K. Khalaji and S. A. A. Moosavian, “Robust adaptive controller for a tractor-trailer mobile robot,” IEEE/ASME Transactions on Mechatronics, vol. 19, no. 3, pp. 943-953, 2014.
[6] J. Yuan, F. Sun, and Y. Huang, “Trajectory generation and tracking control for double-steering tractor-trailer mobile robots with on-axle hitching,” IEEE Transactions on Industrial Electronics, vol. 62, no. 12, pp. 7665-7677, 2015.
[7] Z. Leng and M. Minor, “A simple tractor-trailer backing control law for path following,” in Intelligent Robots and Systems (IROS), 2010 IEEE/RSJ International Conference on, pp. 5538-5542, IEEE, 2010.
[8] F. Lamiraux and J.-P. Laumond, “A practical approach to feedback control for a mobile robot with trailer,” in Robotics and Automation, 1998. Proceedings. 1998 IEEE International Conference on, vol. 4, pp. 3291-3296, IEEE, 1998.
[9] J. Morales, J. L. Mart'inez, A. Mandow, and A. J. Garc'ia-Cerezo, “Steering the last trailer as a virtual tractor for reversing vehicles with passive on-and off-axle hitches,” IEEE Transactions on Industrial Electronics, vol. 60, no. 12, pp. 5729-5736, 2013.
[10] D. Nguyen and B. Widrow, “The truck backer-upper: an example of self-learning in neural networks,” in International 1989 Joint Conference on Neural Networks, pp. 357-363 vol. 2, 1989.
[11] M. Schoenauer and E. Ronald, “Neuro-genetic truck backer-upper controller,” in Proceedings of the First IEEE Conference on Evolutionary Computation. IEEE World Congress on Computational Intelligence, pp. 720-723 vol. 2, June 1994.
[12] A. Gonzalez-Cantos and A. Ollero, “Backing-up maneuvers of autonomous tractor-trailer vehicles using the qualitative theory of nonlinear dynamical systems,” The International Journal of Robotics Research, vol. 28, no. 1, pp. 49-65, 2009.
[13] P. Petrov, “Nonlinear backward tracking control of an articulated mobile robot with off-axle hitching,” in Proc. WSEAS Int. Conf. ISPRA, pp. 269-273, 2010.
[14] K. Tanaka and T. Kosaki, “Design of a stable fuzzy controller for an articulated vehicle,” IEEE Transactions on Systems, Man, and Cybernetics, Part B (Cybernetics), vol. 27, no. 3, pp. 552-558, 1997.
[15] J. Cheng, B. Wang, and Y. Xu, “Backward path tracking control for mobile robot with three trailers,” in International Conference on Neural Information Processing, pp. 32-41, Springer, 2017.
[16] B. Yang, S. Taehyun, and F. Nenglian, “Look-ahead path information based receding horizon control for backing-up tractor-trailer systems,” in 31st Chinese Control Conference, pp. 4201-4206, IEEE, 2012.
[17] Y. Bin and T. Shim, “Constrained model predictive control for backing-up tractor-trailer system,” in Intelligent Control and Automation (WCICA), 2012 10th World Congress on, pp. 2165-2170, IEEE, 2012.
[18] M. Michatek and M. Kietczewski, “Cascaded vfo set-point control for n-trailers with on-axle hitching,” IEEE Transactions on Control Systems Technology, vol. 22, no. 4, pp. 1597-1606, 2014.
[19] M. M. Michatek, “Modular tracking controller for n-trailers with nonzero hitching offsets,” in American Control Conference (ACC), 2015, pp. 5371-5376, IEEE, 2015.
[20] R. Solea and U. Nunes, “Trajectory planning with velocity planner for fully-automated passenger vehicles,” in Intelligent Transportation Systems Conference, 2006. ITSC'06. IEEE, pp. 474-480, IEEE, 2006.
[21] X. Du and K. K. Tan, “Autonomous reverse parking system based on robust path generation and improved sliding mode control,” IEEE Transactions on Intelligent Transportation Systems, vol. 16, no. 3, pp. 1225-1237, 2015.
[22] U. Ozguner, T. Acarman, and K. A. Redmill, . . . Autonomous ground vehicles. Artech House, 2011.
[23] N. Evestedt, O. Ljungqvist, and D. Axehill, “Path tracking and stabilization for a reversing general 2-trailer configuration using a cascaded control approach,” in 2016 IEEE Intelligent Vehicles Symposium (IV), pp. 1156-1161, IEEE, 2016.
[24] W. Gao and J. C. Hung, “Variable structure control of nonlinear systems: A new approach,” IEEE transactions on Industrial Electronics, vol. 40, no. 1, pp. 45-55, 1993.
[25] K. Hornik, M. Stinchcombe, and H. White, “Multilayer feedforward networks are universal approximators,” Neural networks, vol. 2, no. 5, pp. 359-366, 1989.
[26] R. Miikkulainen, Neuroevolution. New York: Springer, 2010.
[27] D. P. Bertsekas and J. N. Tsitsiklis, “Neuro-dynamic programming: an overview,” in Proceedings of the 34th IEEE Conference on Decision and Control, vol. 1, pp. 560-564, IEEE Publ. Piscataway, N.J., 1995.
[28] D. P. Bertsekas, Dynamic programming and optimal control, vol. 1. Athena scientific Belmont, Mass., 2005.
[29] R. S. Sutton, A. G. Barto, and R. J. Williams, “Reinforcement learning is direct adaptive optimal control,” IEEE Control Systems, vol. 12, no. 2, pp. 19-22, 1992.
Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A non-transitory computer-readable storage medium having computer-executable instructions stored thereon for preventing a jackknife condition in a tractor-trailer system comprising a tractor vehicle and a trailer vehicle that, when executed by a processing unit, cause the processing unit to:
receive a plurality of static parameters for the tractor-trailer system, the static parameters comprising a geometry of the tractor-trailer system and a steering limit of the tractor vehicle;
calculate a maneuverable range for an articulation angle of the tractor-trailer system based on the static parameters;
receive a plurality of dynamic parameters for the tractor-trailer system, the dynamic parameters comprising a steering command from a tractor-trailer controller, a longitudinal speed of the tractor vehicle, and a measured articulation angle of the tractor-trailer system; and
detect the jackknife condition when the articulation angle is expected to depart from the maneuverable range.

2. The non-transitory computer-readable storage medium of claim 1, having further computer-executable instructions stored thereon that, when executed by the processing unit, cause the processing unit to:
calculate an expected articulation angle of the tractor-trailer system based on the dynamic parameters; and
determine whether the expected articulation angle is within the maneuverable range, wherein the jackknife condition is detected when the expected articulation angle is outside of the maneuverable range.

3. The non-transitory computer-readable storage medium of claim 2, wherein the expected articulation angle of the tractor-trailer system is calculated using a kinematic model for the tractor-trailer system.

4. The non-transitory computer-readable storage medium of claim 3, wherein the expected articulation angle of the tractor-trailer system is calculated using an analytical equation derived from an approximation of the kinematic model for the tractor-trailer system.

5. The non-transitory computer-readable storage medium of claim 1, wherein detecting the jackknife condition when the articulation angle is expected to depart from the maneuverable range comprises approximating a kinematic model for the tractor-trailer system.

6. The non-transitory computer-readable storage medium of claim 5, wherein the kinematic model for the tractor-trailer system is approximated under a maximum steering rate condition for the tractor vehicle.

7. The non-transitory computer-readable storage medium of claim 5, wherein detecting the jackknife condition when the articulation angle is expected to depart from the maneuverable range further comprises deriving an analytical equation from the approximation of the kinematic model for the tractor-trailer system.

8. The non-transitory computer-readable storage medium of claim 1, having further computer-executable instructions stored thereon that, when executed by the processing unit, cause the processing unit to:
adjust the steering command in response to detecting the jackknife condition; and
transmit the adjusted steering command to the tractor vehicle.

9. The non-transitory computer-readable storage medium of claim 8, wherein adjusting the steering command comprises adjusting at least one of a commanded steering angle for the tractor vehicle or a commanded steering angular rate for the tractor vehicle.

10. The non-transitory computer-readable storage medium of claim 9, wherein adjusting the steering command comprises reducing the commanded steering angle or altering the commanded steering angular rate.

11. The non-transitory computer-readable storage medium of claim 9, wherein adjusting the steering command comprises changing a direction of the commanded steering angle.

12. The non-transitory computer-readable storage medium of claim 1, having further computer-executable instructions stored thereon that, when executed by the processing unit, cause the processing unit to transmit the steering command to the tractor vehicle without adjustment in response to not detecting the jackknife condition.

13. The non-transitory computer-readable storage medium of claim 1, wherein the geometry of the tractor-trailer system comprises a wheelbase of the tractor vehicle, a wheelbase of the trailer vehicle, and a hitch length.

14. The non-transitory computer-readable storage medium of claim 1, wherein the steering limit of the tractor vehicle comprises at least one of a maximum steering angle or a maximum steering angular rate.

15. The non-transitory computer-readable storage medium of claim 1, wherein the articulation angle of the tractor-trailer system is a difference between a heading of the trailer vehicle and a heading of the tractor vehicle.

16. A driver assistance system for a tractor-trailer system including a tractor vehicle and a trailer vehicle, the driver assistance system comprising:
a processing unit and a memory operably coupled to the processing unit;
a tractor-trailer control module comprising computer-executable instructions stored in the memory, wherein the tractor-trailer control module, when executed by the processing unit, is configured to steer one or more wheels of the tractor vehicle; and
a control safety governor module comprising computer-executable instructions stored in the memory, wherein the control safety governor module, when executed by the processing unit, is configured to supervise the tractor-trailer control module to prevent occurrence of a jackknife condition in the tractor-trailer system.

17. The driver assistance system of claim 16, wherein the control safety governor module is further configured to adjust a steering command generated by the tractor-trailer control module in response to detecting the jackknife condition.

18. The driver assistance system of claim 16, wherein supervising the tractor-trailer control module to prevent occurrence of a jackknife condition in the tractor-trailer system comprises:
receiving a plurality of static parameters for the tractor-trailer system, the static parameters comprising a geometry of the tractor-trailer system and a steering limit of the tractor vehicle;
calculating a maneuverable range for an articulation angle of the tractor-trailer system based on the static parameters;
receiving a plurality of dynamic parameters for the tractor-trailer system, the dynamic parameters comprising a steering command from the tractor-trailer control module, a longitudinal speed of the tractor vehicle, and a measured articulation angle of the tractor-trailer system; and
detecting the jackknife condition when the articulation angle is expected to depart from the maneuverable range.

19. A tractor-trailer system, comprising:
the tractor vehicle;
the trailer vehicle hitched to the tractor vehicle; and
the driver assistance system of claim 16.

20. The tractor-trailer system of claim 19, wherein the tractor and trailer vehicles are hitched off-axle.
